(19) United States
(12) Patent Application Publication
(10) Pub. No.: US 2014/0380161 A1
(43) Pub. Date: Dec. 25, 2014

(54) INFORMATION PROCESSING APPARATUS, INFORMATION PROCESSING METHOD, AND PROGRAM

(71) Applicant: SONY CORPORATION, TOKYO (JP)

(72) Inventors: HIKOTATSU CHIN, Tokyo (JP); TAKASHI KITAO, Tokyo (JP); KOJI IHARA, Chiba (JP); KATSUYA HYODO, Kanagawa (JP); RYO FUKAZAWA, Kanagawa (JP)

(21) Appl. No.: 14/302,917

(22) Filed: Jun. 12, 2014

(30) Foreign Application Priority Data
Jun. 21, 2013 (JP) 2013-130505

(51) Int. Cl. G06F 3/0484; G06F 3/0481

(52) U.S. Cl. CPC G06F 3/0484; G06F 3/04817
USPC 715/716

(57) ABSTRACT

There is provided an information processing apparatus including a communication unit that is capable of communicating with a communication apparatus through a communication network, and a control unit configured to perform control to place, in a virtual space, a communication-apparatus image that represents the communication apparatus and content being executed by the communication apparatus, and to display the virtual space.

### CROSS REFERENCE TO RELATED APPLICATIONS

This application claims the benefit of Japanese Priority Patent Application JP 2013-130505 filed Jun. 21, 2013, the entire contents of which are incorporated herein by reference.

### BACKGROUND

The present disclosure relates to an information processing apparatus, an information processing method, and a program.

In a technique disclosed in JP 2011-217236A, operation modes are automatically switched in cooperation between a mobile device and a display device. In addition, in the techniques disclosed in JP 2011-217236A, a list of output devices connected to a network are displayed with icons. A user drops a content icon to an icon of an output device so as to cause the desired output device to execute content. In a technique disclosed in JP 2007-104567A, a list of device icons such as a television and a DVD recorder and content icons indicating kinds of broadcasting (such as analog terrestrial broadcasting) is displayed. In addition, in the technique, an application is executed when a content icon corresponding to the application is dragged and dropped to a device icon. In a technique disclosed in JP 2004-129154A, lists of source devices connected to a network and pieces of content of the source devices are acquired, and an operation for causing an output device connected to the network to playback the pieces of content is supported.

### SUMMARY

However, in the techniques disclosed in JP 2011-217236A, JP 2007-104567A, and JP 2004-129154A, it is difficult for a user to intuitively recognize content being executed by a communication apparatus connected to a network. Accordingly, technology has been sought after which is able to cause a user to intuitively recognize content being executed by a communication apparatus.

According to an embodiment of the present disclosure, there is provided an information processing apparatus including a communication unit that is capable of communicating with a communication apparatus through a communication network, and a control unit configured to perform control to place, in a virtual space, a communication-apparatus image that represents the communication apparatus and content being executed by the communication apparatus, and to display the virtual space.

According to an embodiment of the present disclosure, there is provided an information processing method including communicating with a communication apparatus through a communication network, and performing control to place, in a virtual space, a communication-apparatus image that represents the communication apparatus and content being executed by the communication apparatus, and to display the virtual space.

According to an embodiment of the present disclosure, there is provided an program for causing a computer to achieve a communication function that is capable of communicating with a communication apparatus through a communication network, and a control function configured to perform control to place, in a virtual space, a communication-apparatus image that represents the communication apparatus and content being executed by the communication apparatus, and to display the virtual space.

According to one or more of embodiments of the present disclosure, a control unit performs control to place, in a virtual space, a communication-apparatus image that represents a communication apparatus and content being executed by the communication apparatus, and to display the virtual space. Accordingly, by visually recognizing the virtual space, the user can intuitively recognize content being executed by a communication apparatus.

According to the embodiments of the present disclosure such as described above, the user can intuitively understand content being executed by a communication apparatus by visually recognizing the virtual space.

### BRIEF DESCRIPTION OF THE DRAWINGS

FIG. 1 is a block diagram showing a configuration of an information processing system according to an embodiment of the present disclosure;

FIG. 2 is a block diagram showing a configuration of a server according to the embodiment; and

FIG. 3 is a block diagram showing a configuration of a communication apparatus;

FIG. 4 is a flowchart showing a procedure of processing performed by a server;

FIG. 5 is an explanatory diagram showing an example of a virtual space;

FIG. 6 is an explanatory diagram showing an example of a virtual space;

FIG. 7 is an elevation view showing an outer appearance of a speaker which is an example of a communication apparatus having no display unit;

FIG. 8 is an explanatory diagram showing an example of a virtual space;

FIG. 9 is an explanatory diagram showing an example of a virtual space;

FIG. 10 is an explanatory diagram showing an example where a virtual space is displayed on a display unit of a communication apparatus;

FIG. 11 is an explanatory diagram showing an example where a virtual space is displayed on a display unit of a communication apparatus;

FIG. 12 is a plane view showing an example where communication apparatuses are placed in a real space;

FIG. 13 is an explanatory diagram showing an example where a virtual space is displayed on a display unit of a communication apparatus;

FIG. 14 is an explanatory diagram showing an example where a virtual space is displayed on a display unit of a communication apparatus;

FIG. 15 is a sequence diagram showing a procedure of processing performed by an information processing system;

FIG. 16 is an explanatory diagram showing an example where a virtual space is displayed on a display unit of a communication apparatus;

FIG. 17 is an explanatory diagram showing an example where a virtual space is displayed on a display unit of a communication apparatus;

FIG. 18 is an explanatory diagram showing an example where virtual content in a virtual space is moved in response to a user operation;

FIG. 19 is an explanatory diagram showing an example where content is transferred between communication apparatuses;

FIG. 20 is an explanatory diagram showing an example where content is shared among communication apparatuses;

FIG. 21 is a plane view showing an example where communication apparatuses are placed in a real space;

FIG. 22 is an explanatory diagram showing an example of a virtual space;

FIG. 23 is an explanatory diagram showing an example where virtual content in a virtual space is moved in response to a user operation;

FIG. 24 is an explanatory diagram showing an example where content is displayed across communication apparatuses;

FIG. 25 is an explanatory diagram showing an example where function-display images of respective communication-apparatus images are associated with another communication-apparatus image in response to a user operation;

FIG. 26 is an explanatory diagram showing an example where a function-display image of each communication-apparatus image is associated with another communication-apparatus image in response to a user operation;

FIG. 27 is an explanatory diagram showing an example of a virtual space;

FIG. 28 is an explanatory diagram showing an example where function-display images of a communication-apparatus image are associated with other communication-apparatus images in response to a user operation;

FIG. 29 is a plane view showing an example where communication apparatuses are placed in a real space;

FIG. 30 is an explanatory diagram showing an example of operation of virtual content in a virtual space;

FIG. 31 is an explanatory diagram showing an example where virtual content in a virtual space is changed in response to a user operation; and

FIG. 32 is a plane view showing an example where content displayed on a communication apparatus is changed.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The description will be given in the following order.

### 1. Consideration of Background Art

### 2. Schematic Configuration of Information Processing System

### 2-1. Overall Configuration

### 2-2. Configuration of Server

### 2-3. Configuration of Communication Apparatus

### 3. Procedure of Processing Performed by Server

### 4. Operation Using Virtual Space

### 4-1. Procedure of Processing Performed by Information Processing System

### 4-2. Various Display Examples

### 4-2-1. Zoom In and Zoom Out of Virtual Space

### 4-2-2. Switching Display/Non-Display of Virtual Space

### 4-2-3. Transfer of Content

### 4-2-4. Sharing of Content

### 4-2-5. Sharing of Arbitrarily-Acquired Content

### 4-2-6. Function Transfer Example 1

### 4-2-7. Function Transfer Example 2

### 4-2-8. Function Transfer Example 3

### 4-2-9. Example of Operation of Virtual Content in Virtual Space

<1. Consideration of Background Art>

The present inventors have been arrived at an information processing system according to embodiments of the present disclosure by considering the background of the embodiments of the present disclosure. First, the background arts of the embodiments of the present disclosure will be described.

Recent audio/video devices and information devices actively perform device-to-device cooperation where devices are connected and content is operated and shared. For example, there has been proposed an example of watching a program recorded by a recorder on a tablet computer in another room, and an example where music stored in a personal computer is forwarded to a music player in a place away from the personal computer through a network and is playback by the music player. It is thought that an expansion of such device-to-device function will continue and corresponding devices will be increased. Many devices used by users are expected to be able to cooperate with each other in the future. JP 2011-217236A, JP 2007-104567A, and JP 2004-129154A, which are described above, disclose techniques to improve operability regarding such device-to-device cooperation.

However, in these techniques, it is difficult for the user to intuitively recognize content being executed by a communication apparatus connected to a network.

Specifically, in the techniques disclosed in JP 2011-217236A, JP 2007-104567A, and JP 2004-129154A, a list of communication devices connected to a network are displayed with icons. Accordingly, by visually recognizing these icons, a user can recognize the communication apparatuses connected to the network. However, it is difficult for the user to intuitively recognize content being executed by each of the communication apparatuses. Accordingly, for example, it is difficult for the user to perform an operation based on the content being executed by each of the communication apparatuses (for example, an operation to share content being executed by a communication apparatus with another communication apparatus).

On the basis of the above-described background arts, the present inventors has been achieved the information processing system according to the embodiments of the present disclosure. First, an information processing system according to an embodiment of the present disclosure places, in a virtual space, communication-apparatus images each of which represents respective communication apparatuses connected to the network and content being executed by the respective communication apparatuses, and displays the virtual space. Accordingly, by visually recognizing the communication-apparatus images in the virtual space, the user can intuitively recognize the content being executed by respective communication apparatuses in overhead view without depending on letters or icons.

Second, on the basis of user operations, the information processing system can connect a plurality of communication apparatuses, transfer/share content, and further transfer/share a function of each communication apparatus between the communication apparatuses.

From the above, the user can visually and intuitively recognize content being executed by respective communication apparatuses and connection status (cooperation status). In addition, the user can intuitively perform operations such as causing communication apparatuses to share content and functions. Accordingly, it is possible for the information processing system to improve operability when a plurality of communication apparatuses cooperate with each other.

<2. Schematic Configuration of Information Processing System>

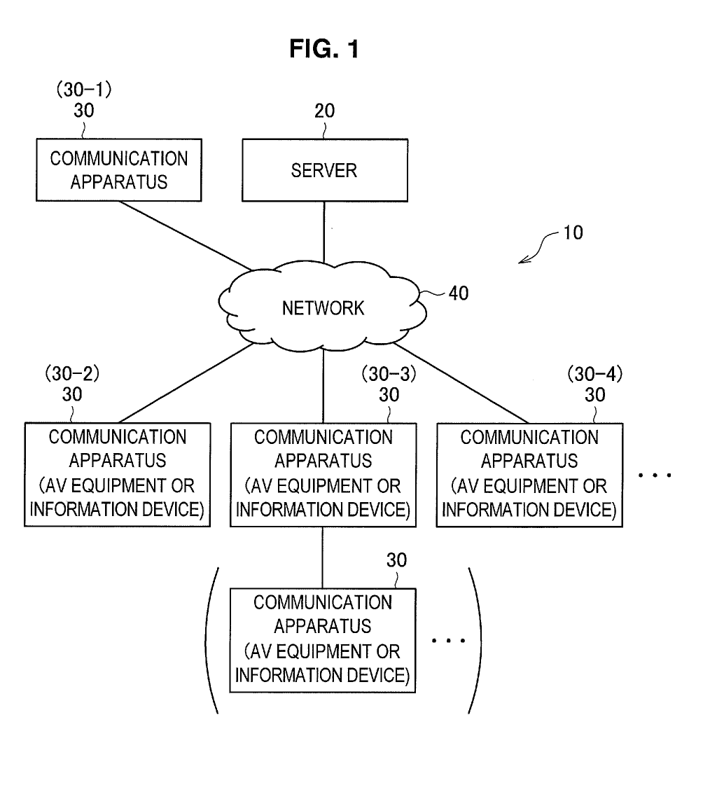

Next, with reference to FIGS. 1 to 3, there will be described a schematic configuration of an information processing system 10 according to an embodiment of the present disclosure.

(2-1. Overall Configuration)

As shown in FIG. 1, the information processing system 10 includes a server (information processing apparatus) 20, one or more communication apparatus 30, and a network 40. The server 20 that is connected to the network 40 generates a virtual space, places communication-apparatus images and the like in the virtual space, and performs display control, for example. The communication apparatuses 30 that are connected to the network 40 execute content, for example. On at least one of the communication apparatuses 30, it is possible for a user to perform an input operation. The communication apparatus 30 on which the user performs the input operation displays the virtual space and the like in addition to executing the content.

Types of the communication apparatuses 30 are not especially limited as long as the communication apparatuses 30 are connectable to the network 40. For example, the communication apparatuses 30 may be various audio/video devices and information devices. More specifically, the communication apparatuses 30 may be various personal computers (a desktop computer, a laptop, and the like), a smartphone, a smart tablet, a mobile phone, a television (television receiver), a speaker and the like. Note that, it is not necessary for the communication apparatuses 30 to directly connect to the network 40, and the communication apparatuses 30 may be connected to the network 40 through another communication apparatus 30. Moreover, the number of the communication apparatuses 30 is not limited. The number of the communication apparatuses 30 may be one or more. The network 40 interconnects the server 20 and the communication apparatuses 30. The server 20 and the communication apparatuses 30 communicate various information through the network 40. Types of the network 40 are not especially limited as well. For example, the network 40 may be a home network, or a network broader than the home network.

(2-2. Configuration of Server)

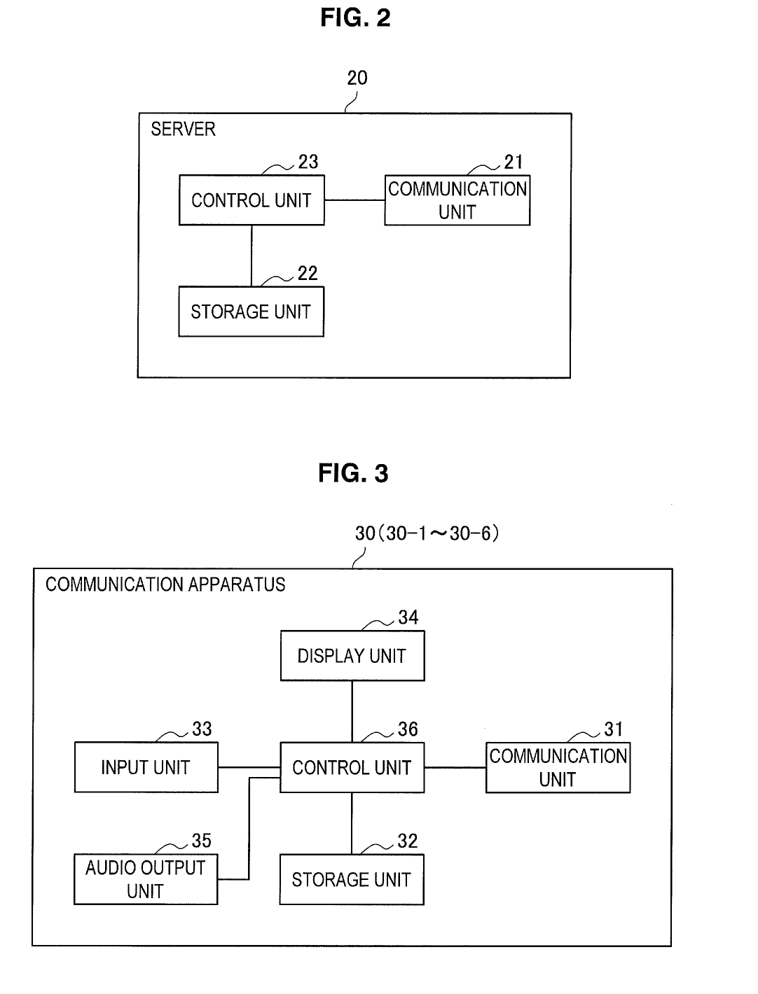

As shown in FIG. 2, the server 20 includes a communication unit 21, a storage unit 22, and a control unit 23. The server 20 includes hardware configurations such as a CPU, ROM, RAM, a hard disk, and various communication circuits, and achieves the above-described functions by using the hardware configurations. That is, the ROM stores a program for causing the server 20 to achieve the communication unit 21, the storage unit 22, and control unit 23. The CPU reads and executes the program stored in the ROM. Accordingly, the communication unit 21, the storage unit 22, and control unit 23 are achieved. Note that, the server 20 may include functions other than the above, such as a display unit and an input unit. In the case where the server 20 includes the display unit, the virtual space may be displayed on the display unit of the server 20.

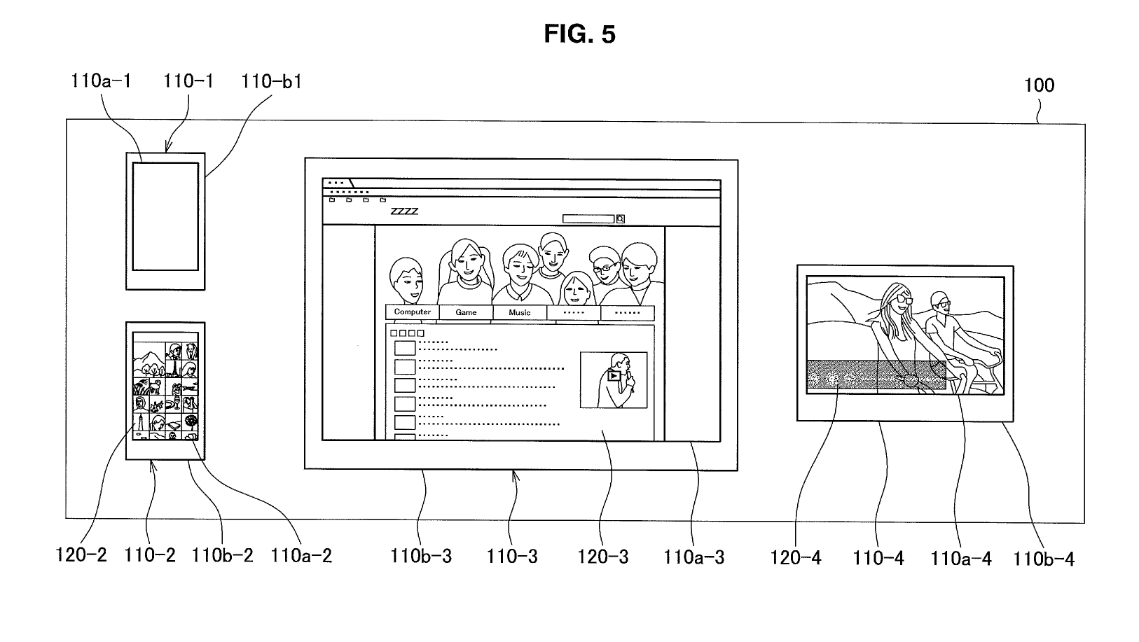

The communication unit 21 communicates with the communication apparatuses 30 through the network 40. The storage unit 22 stores the above-described program and the like. The control unit 23 generates the virtual space and further generates communication-apparatus images (for example, see communication-apparatus images 110-1 to 110-4 shown in FIG. 5) that represent the communication apparatuses 30 and content being executed by the communication apparatuses 30. The control unit 23 places respective communication images in the virtual space. In addition, the control unit 23 transmits virtual-space information about the virtual space to any one of the communication apparatuses 30. The any one of communication apparatuses 30 displays the virtual space. Accordingly, the user can visually recognize communication-apparatus images that represent the communication apparatuses 30 and content being executed by the communication apparatuses 30, and accordingly can see the content being executed by the communication apparatuses 30 in an overhead view as if watching a Bird's eye map. Accordingly, the user can intuitively recognize the content being executed by the respective communication apparatuses 30 in overhead view.

(2-3. Configuration of Communication Apparatus)

As shown in FIG. 3, the communication apparatuses 30 each include a communication unit 31, a storage unit 32, an input unit 33, a display unit 34, an audio output unit 35, and a control unit 36. The communication apparatuses 30 each include hardware configurations such as a CPU, ROM, RAM, a hard disk, a display, various input devices (such as a touchscreen, a keyboard, and a mouse) and various communication circuits, and achieve the above-described functions by using the hardware configurations. That is, the ROM stores a program for causing each of the communication apparatuses 30 to achieve the communication unit 31, the storage unit 32, the input unit 33, the display unit 34, the audio output unit 35, and the control unit 36. The CPU reads and executes the program stored in the ROM. Accordingly, the communication unit 31, the storage unit 32, the input unit 33, the display unit 34, the audio output unit 35, and the control unit 36 are achieved. Note that, functions of the communication apparatuses 30 are not limited to the above. Any communication apparatuses 30 can be used if the communication apparatuses 30 are connectable with the network 40 at least. In addition, at least one of the communication apparatuses 30 includes the display unit 34. The one of the communication apparatuses 30 including the display unit 34 can display the virtual space. It is preferable for the one of the communication apparatuses 30 including the display unit 34 to further include the input unit 33. The one of the communication apparatuses 30 including the input unit 33 and the display unit 34 can move each image in the virtual space in response to an input operation.

The communication unit 31 communicates with another communication apparatus 30 and the server 20 through the network 40. The storage unit 33 stores the above-described program and the like. The input unit 33 receives an input operation performed by the user. The display unit 34 displays various information such as the virtual space and the content (image content). Note that, types of image content is not limited. The image content may be a web page, a still image, and a video, for example. The audio output unit 35 outputs content (audio content) by a sound. The control unit 36 controls whole of the one of the communication apparatuses 30.

The control unit 36 may detect a current position of the one of the communication apparatuses 30. The detection processing is not especially limited. For example, the control unit 36 may acquire GPS information through the communication unit 31 and detect the current position based on the GPS information. The control unit 36 outputs, to the server 20, communication-apparatus information indicating types and current positions of the communication apparatuses 30, content (for example, content being displayed on the display unit 34) being executed by the communication apparatuses 30, and functions held by the communication apparatuses 30. Here, the types of the communication apparatuses 30 may be information indicating classification such as a personal computer, a smartphone, a smart tablet, and a television receiver. Examples of the functions held by the communication apparatuses 30 include image display (video display), audio output, input operation, audio input, and remote control (also referred to as remote). The audio output can be further classified into output from a speaker and output from headphones. The control unit 23 performs above-described processing by using the communication-apparatus information. Communication apparatuses 30-1 to 30-6 described later are one of the communication apparatuses 30, respectively.

<3. Procedure of Processing Performed by Server>

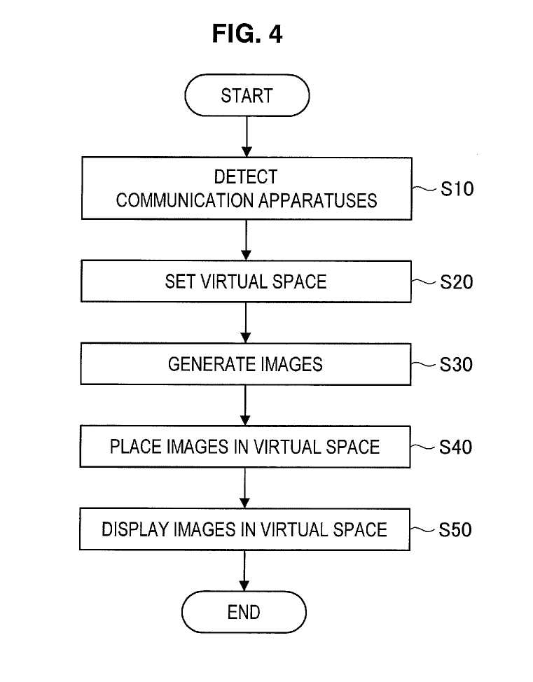

Next, with reference to a flowchart shown in FIG. 4, a procedure of processing performed by the server 20 is explained. Here, processing up to display of a virtual space will be explained.

In step S10, control units 36 of respective communication apparatuses 30 acquire GPS information through communication units 31, and detect current positions based on the GPS information. Subsequently, the control units 36 output, to the server 20, communication-apparatus information indicating types and current positions of the communication apparatuses 30, content being executed by the communication apparatuses 30, and functions held by the communication apparatuses 30 (or, names of apparatuses executing such functions). The communication unit 21 of the server 20 acquires communication-apparatus information and outputs to the control unit 23. The control unit 23 detects communication apparatuses 30 on the basis of the communication-apparatus information.

In step S20, the control unit 23 sets a virtual space. The virtual space may be any one of two-dimensional space and three-dimensional space.

In step S30, the control unit 23 generates communication-apparatus images based on the communication-apparatus information, the communication-apparatus images representing the communication apparatuses 30 and content being executed by the communication apparatuses 30. The communication-apparatus images include main-body images representing outer appearances of the communication apparatuses 30, and virtual content representing content being executed by the communication apparatuses 30. In the case where the communication apparatuses 30 have display units, the virtual content are displayed on display-unit images corresponding to the display units. In addition, in the case where one of the communication apparatuses 30 is executing audio content, virtual content may be an image indicating that the audio content is being executed (played back). An example of such image includes a music-note image, an icon indicating that music is currently played back, and a display screen of a music player. The music-note image is preferable in the case where one of the communication apparatus 30 does not have a display unit. In the case where the one of the communication apparatuses 30 has a display unit, the music-note image, icon, or display screen of the music player may be displayed on the display-unit image of the communication-apparatus image. It may be possible that two or more of such images are displayed, or two or more of such images are displayed with being overlapped each other.

Moreover, in the case where one of the communication apparatuses 30 does not have a display unit, the control unit 23 places an operation image used for operating one of the communication apparatuses 30 near an communication-apparatus image. For example, in the case where one of the communication apparatuses 30 is a speaker having no display unit, the control unit 23 places an operation image including a play button and the like, near a communication-apparatus image.

In addition, the control unit 23 generates function-display images indicating functions held by the communication apparatuses 30. For example, the function-display images may be icons on which text is written, the text being combination of types (or abbreviations thereof) and functions (or abbreviations thereof) of the communication apparatuses 30.

More specifically, for example, a function-display image indicating an audio-output function of a smartphone is a text icon on which “Smartphone Sound” (“smartphone”+“sound”) is written. A function-display image indicating a video (image) output function of a smartphone is a text icon on which “Smartphone Image” (“smartphone”+“image”) is written. A function-display image indicating an audio-input function of a smartphone is a text icon on which “Smartphone Audio Input” (“smartphone”+“audio input”) is written. An input-operation function (for example, input-operation function using a touchscreen) of a smartphone is a text icon on which “Smartphone Operation” (“smartphone”+“operation”) is written.

A function-display image indicating an audio output function of a television receiver is a text icon on which “TV Sound” (“TV”+“sound”) is written. A function-display image indicating a remote-control function of a television receiver is a text icon on which “TV Remote” (“TV”+“remote control”) is written. A function-display image indicating an audio output function of a smart tablet is a text icon on which “Tab Sound” (“tablet”+“sound”) is written. A function-display image indicating an audio output function of a speaker is a text icon on which “Speaker Sound” (“speaker”+“sound”) is written.

The function-display images may be text icons on which names of apparatuses executing functions of the communication apparatuses 30 are written. Here, the apparatuses may be built in the communication apparatuses 30 or may be externally mounted on the communication apparatuses 30. For example, a name of an apparatus executing an audio-output function is “Speaker” or “Headphones”. A name of an apparatus executing an image-output function is “Display”. A name of an apparatus executing a remote-control function is “Remote Control”. A name of an apparatus executing an input-operation function is “Keyboard”.

The function-display images may be icons indicting content being executed by the communication apparatuses 30. Information written on the function-display images are not limited to text information. For example, the function-display images may be illustrations, icons, or photos that indicate outer appearances of the apparatuses. In addition, the control unit 23 does not have to generate function-display images for whole functions held by the communication apparatuses 30. For example, the control unit 23 may generate only a function-display image corresponding to a function that is supposed to be frequently used by a user.

In step S40, the control unit 23 places a communication-apparatus image and a function-display image in the virtual space. Specifically, in the virtual space, the control unit 23 places communication-apparatus images in positions according to current positions of the communication apparatuses 30. In addition, the control unit 23 places function-display images near the communication-apparatus images.

In the virtual space, the control unit 23 places communication-apparatus images in positions according to current positions of the communication apparatuses 30. However, there is no specific limitation on a placement of the communication-apparatus images. That is, when placing the communication-apparatus images in the virtual space, the control unit 23 does not have to consider current positions of the communication apparatuses 30. In this case, the communication apparatuses 30 do not have to detect the current positions. In addition, the control unit 23 may omit generation and a placement of the function-display image.

As an example of the virtual space, FIG. 5 shows a virtual space 100. In this example, the communication apparatuses 30-1 to 30-4 are connected to the network 40, and the virtual space is displayed on the communication apparatus 30-1. The communication apparatuses 30-1 and 30-2 are smartphones, the communication apparatus 30-3 is a television receiver, and the communication apparatus 30-4 is a smart tablet. In the virtual space 100, communication-apparatus images 110-1 to 110-4 are placed. An example of the function-display images will be described later.

The communication-apparatus image 110-1 represents the communication apparatus 30-1. The communication-apparatus image 110-1 includes a main-body image 110b-1 representing an outer appearance of the smartphone. Since the virtual space is displayed on the communication apparatus 30-1 in this example, a display-unit image 110a-1 corresponding to a display unit of the communication apparatus 30-1 in the communication-apparatus image 110-1 is blank. In the case where the communication apparatus 30-1 displays content and the other communication apparatuses 30 display the virtual space, the display-unit image 110a-1 displays virtual content representing content being executed by the communication apparatus 30-1.

In a similar way, a communication-apparatus image 110-2 represents the communication apparatus 30-2 and content being executed by the communication apparatus 30-2. That is, the communication-apparatus image 110-2 includes a main-body image 110b-2 representing an outer appearance of a smartphone, and virtual content 120-2 representing content (image content) being executed by the communication apparatus 30-2. The virtual content 120-2 is displayed on a display-unit image 110a-2 corresponding to a display unit of the communication apparatus 30-2 in the main-body image 110b-2.

A communication-apparatus image 110-3 represents the communication apparatus 30-3 and content being executed by the communication apparatus 30-3. That is, the communication-apparatus image 110-3 includes a main-body image 110b-3 representing an outer appearance of the television receiver, and virtual content 120-3 representing content (image content) being executed by the communication apparatus 30-3. The virtual content 120-3 is displayed on a display-unit image 110a-3 corresponding to a display unit of the communication apparatus 30-3 in the main-body image 110b-3.

A communication-apparatus image 110-4 represents the communication apparatus 30-4 and content being executed by the communication apparatus 30-4. That is, the communication-apparatus image 110-4 includes a main-body image 110b-4 representing an outer appearance of the smart tablet, and virtual content 120-4 representing content (image content) being executed by the communication apparatus 30-4. The virtual content 120-4 is displayed on a display-unit image 110a-4 corresponding to a display unit of the communication apparatus 30-4 in the main-body image 110b-4.

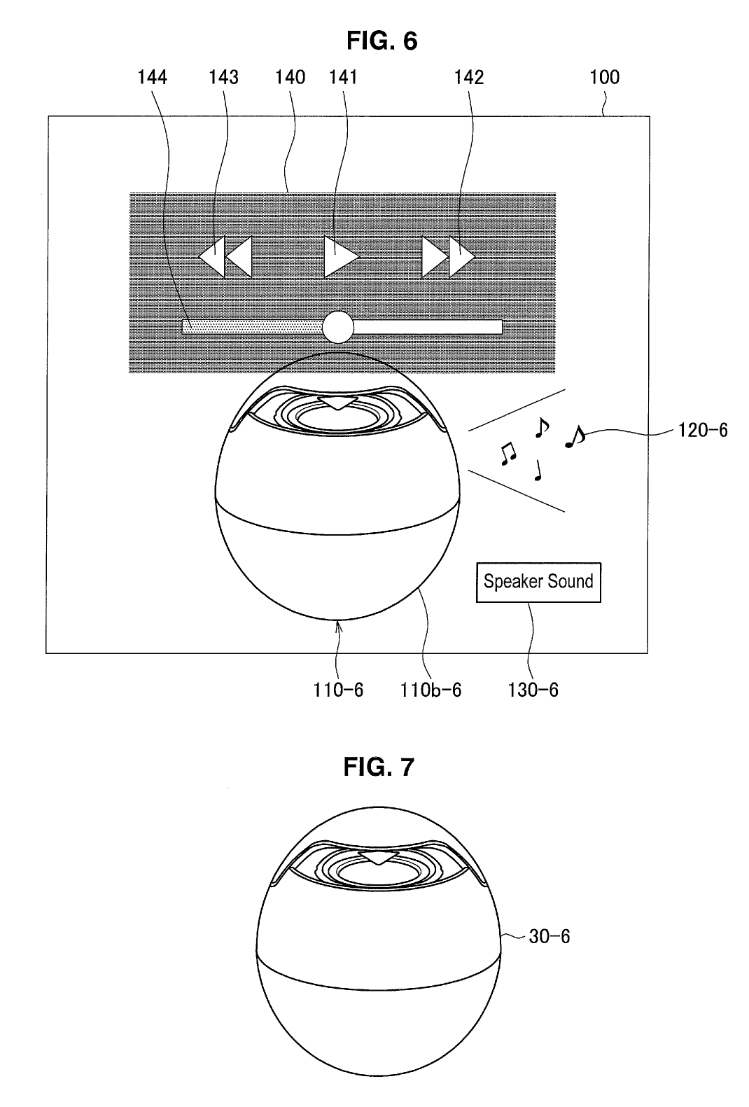

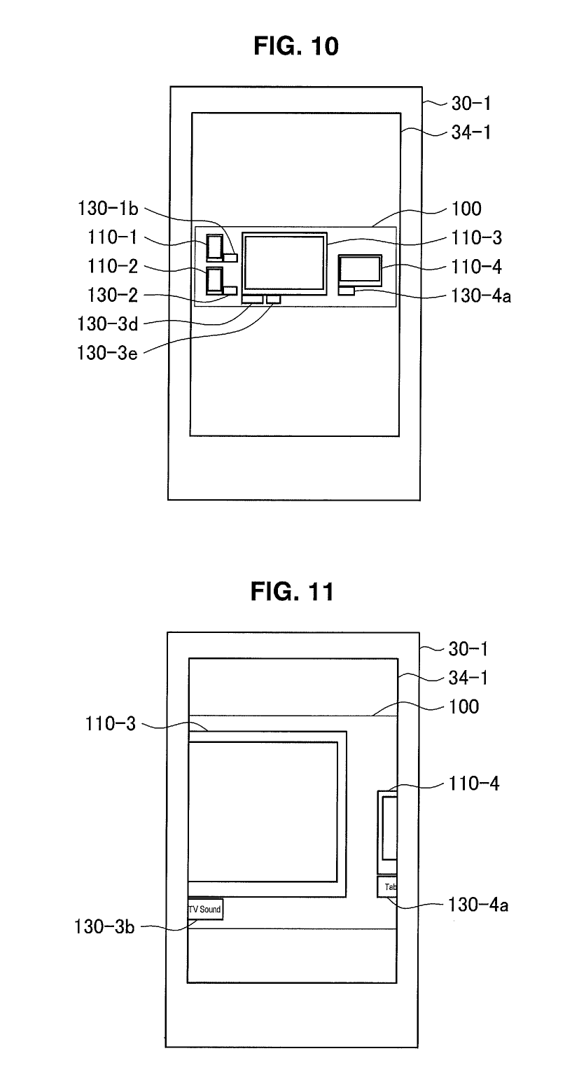

FIG. 6 shows another example of the virtual space. In this example, in addition to the above-described communication apparatuses 30-1 to 30-4, a communication apparatus 30-6 (speaker) shown in FIG. 7 is connected to the network 40. The communication apparatus 30-6 may be directly connected to the network 40, or may be connected to the network 40 through another communication apparatus, such as the communication apparatus 30-3. In the virtual space 100, a communication-apparatus image 110-6 representing the communication apparatus 30-6 and content being executed by the communication apparatus 30-6 is placed. FIG. 6 shows only a partial region around the communication-apparatus image 110-6 in the virtual space 100. The communication-apparatus image 110-6 includes a main-body image 110b-6 representing an outer appearance of a speaker and virtual content 120-6 representing audio content being executed by the communication apparatus 30-6. In this example, the virtual content 120-6 is a music-note image. In the case where the virtual space 100 is displayed on the display unit 34-1 of the communication apparatus 30-1 (see FIG. 10), the control unit 23 may cause the audio content being executed by the communication apparatus 30-6 to be output from the audio output unit 35 of the communication apparatus 30-1.

Near the communication-apparatus image 110-6, a function-display image 130-6 and an operation image 140 are placed. Since the communication apparatus 30-6 has an audio-output function, the function-display image 130-6 indicates “Speaker Sound”. The operation image 140 is an image for a user to operate the communication apparatus 30-6. In this example, the operation image 140 includes a play button 141, a fast forward button 142, a rewind button 143, and a volume control slider 144. In the case where the virtual space 100 is displayed on the display unit 34-1 of the communication apparatus 30-1, the user can operate the communication apparatus 30-6 by tapping a desired button among the above-described buttons. Needless to say, the operation image is not limited to this example.

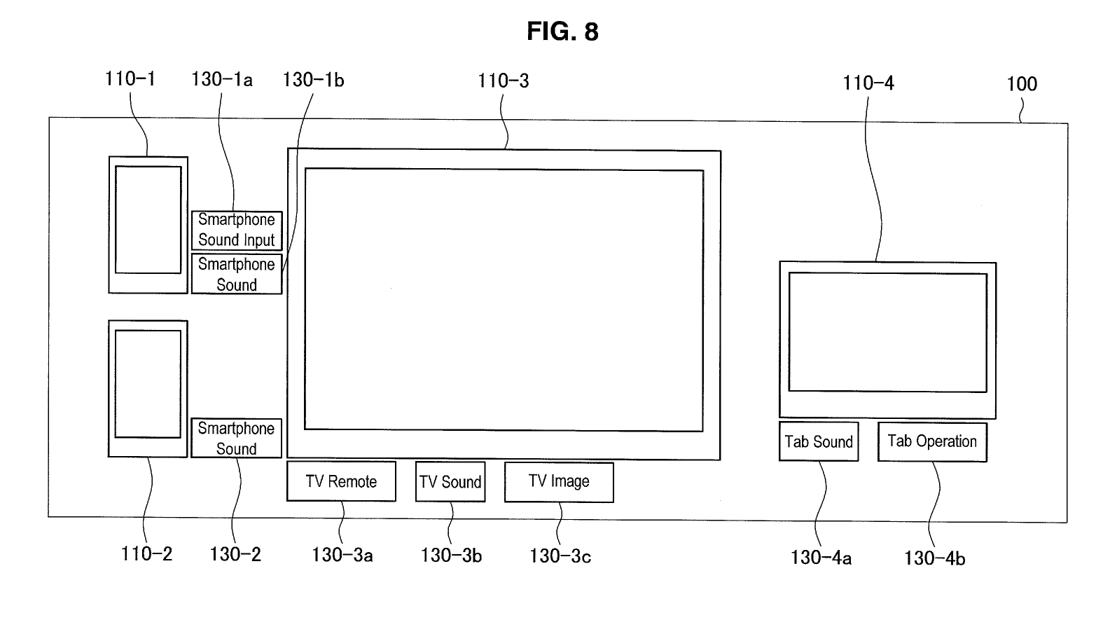

FIG. 8 shows an example of a virtual space in which function-display images are placed. This example is obtained by adding the function-display images to the virtual space 100 shown in FIG. 5. On the function-display images, text indicating functions of the communication apparatuses 30 are written. Note that, the virtual content is omitted in this example.

Near the communication-apparatus image 110-1, function-display images 130-1a and 130-1b indicating functions of the communication apparatus 30-1 are placed. “Smartphone Sound Input” is written on the function-display image 130-1a, and “Smartphone Sound” is written on the function-display image 130-1b.

In a similar way, near the communication-apparatus image 110-2, a function-display image 130-2 indicating a function of the communication apparatus 30-2 is placed. “Smartphone Sound” is written on the function-display image 130-2.

In a similar way, near the communication-apparatus image 110-3, function-display images 130-3a, 130-3b, and 130-3c indicating functions of the communication apparatus 30-3 are placed. “TV Remote” is written on the function-display image 130-3a, “TV Sound” is written on the function-display image 130-3b, and “TV Image” is written on the function-display image 130-3c.

In a similar way, near the communication-apparatus image 110-4, function-display images 130-4a and 130-4b indicating functions of the communication apparatus 30-4 are placed. “Tab Sound” is written on the function-display image 130-4a, and “Tab Operation” is written on the function-display image 130-4b.

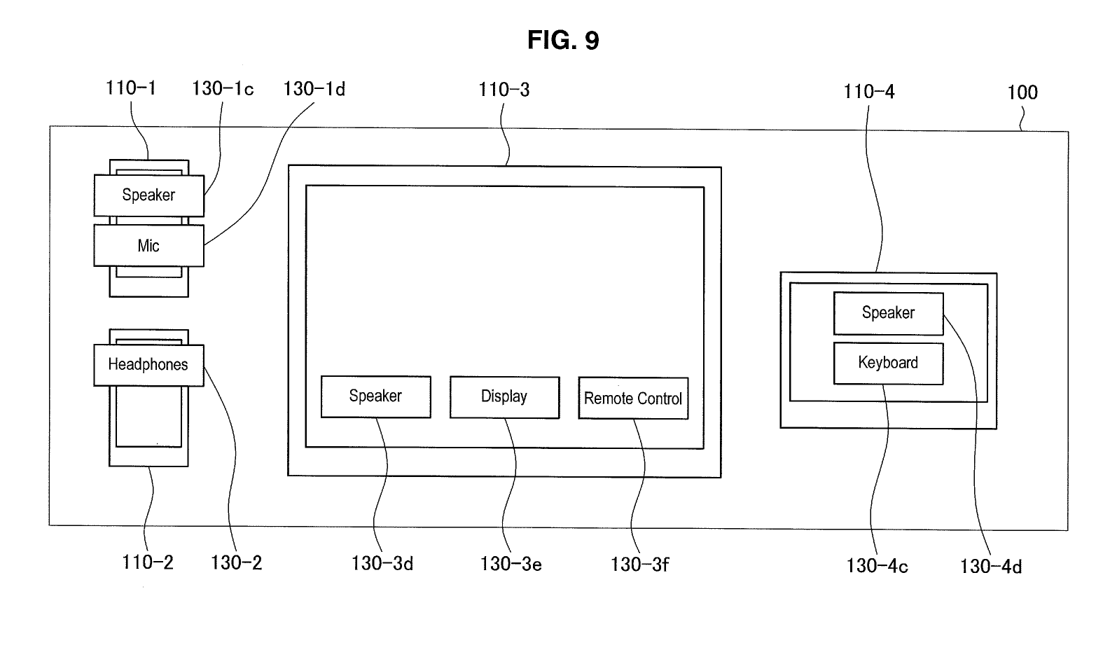

FIG. 9 shows another example of a virtual space in which function-display images are placed. This example is obtained by adding the function-display images to the virtual space 100 shown in FIG. 5. On the function-display images, names of apparatuses executing functions of the communication apparatuses 30 are written. Note that, the virtual content is omitted in this example.

Near the communication-apparatus image 110-1, function-display images 130-1c and 130-1d with names of apparatuses executing functions of the communication apparatus 30-1 written on them are placed. “Speaker” is written on the function-display image 130-1c, and “Mic” is written on the function-display image 130-1d.

In a similar way, near the communication-apparatus image 110-2, a function-display image 130-2 with a name of an apparatus executing a function of the communication apparatus 30-2 written on it is placed. “Headphones” is written on the function-display image 130-2.

In a similar way, near the communication-apparatus image 110-3, function-display images 130-3d, 130-3e, and 130-3f with names of apparatuses executing functions of the communication apparatus 30-3 written on them are placed. “Speaker” is written on the function-display image 130-3d, “Display” is written on the function-display image 130-3e, and “Remote Control” is written on the function-display image 130-3f.

In a similar way, near the communication-apparatus image 110-4, function-display images 130-4c and 130-4d with names of apparatuses executing functions of the communication apparatus 30-4 written on them are placed. “Keyboard” is written on the function-display image 130-4c, and “Speaker” is written on the function-display image 130-4d.

In step S50, the control unit 23 output virtual-space information about the generated virtual space (where the above-described images are placed in the virtual space) to the communication unit 21, and the communication unit 21 transmits the virtual-space information to any one of the communication apparatuses 30. In the example shown in FIG. 5, the communication unit 21 transmits the virtual-space information about the virtual space 100 to at least the communication apparatus 30-1. The communication units 31 of the communication apparatuses 30 receive the virtual space information, and output to the control units 36. The control units 36 display the virtual space based on the virtual-space information on the display units 34.

FIGS. 10 and 11 show display examples. In these examples, the display unit 34-1 of the communication apparatus 30-1 displays the virtual space 100 (some function-display images are omitted) shown in FIG. 8. FIG. 10 is an example in which the whole virtual space 100 is displayed, and FIG. 11 is an example in which the virtual space 100 is zoomed in and displayed. By performing a pinch-in operation or a pinch-out operation, the user can switch a display shown in FIG. 10 and a display shown in FIG. 11. Details will be described later. By visually recognizing the virtual space, the user can intuitively recognize, in overhead view, not only types of communication apparatuses connected to the network, but also what kinds of content respective communication apparatuses is currently executing. Moreover, the user of the communication apparatus 30-1 can intuitively recognize, in real time, what kinds of operations users of the other communication apparatuses 30-2 to 30-4 are going to perform.

In every examples of the virtual spaces described above, the virtual spaces are two-dimensional spaces. However, the virtual spaces are not limited to the two-dimensional spaces, and may be three-dimensional spaces. In this case, the control unit 23 of the server 20 sets a virtual space as a three-dimensional space, and further sets main-body images as three-dimensional images. In addition, the control unit 36 of the one of the communication apparatuses 30 sets a viewpoint to a current position (or position behind the current position) of the one of the communication apparatuses 30 and displays the virtual space. Here, a direction from the display unit of the one of the communication apparatuses 30 to a back of the one of the communication apparatuses 30 is set as an anterior direction. Accordingly, since the user can visually recognize the virtual space from a viewpoint of the current position (or position behind the current position) of the user, the user can easily associate positions of respective communication-apparatus images in the virtual space with positions of respective communication apparatuses 30 in a real space. In addition, since the virtual space is the three-dimensional space, the virtual space is more similar to the real space. Accordingly, the user can intuitively recognize more what kinds of content respective communication apparatuses are currently executing. Note that, the viewpoint is not limited to the above example. For example, the viewpoint may be set to a ceiling of the real space.

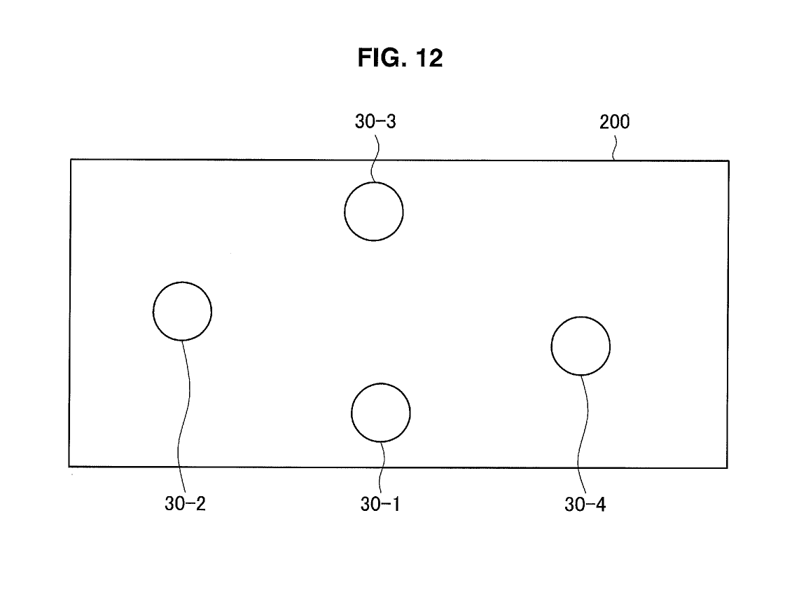

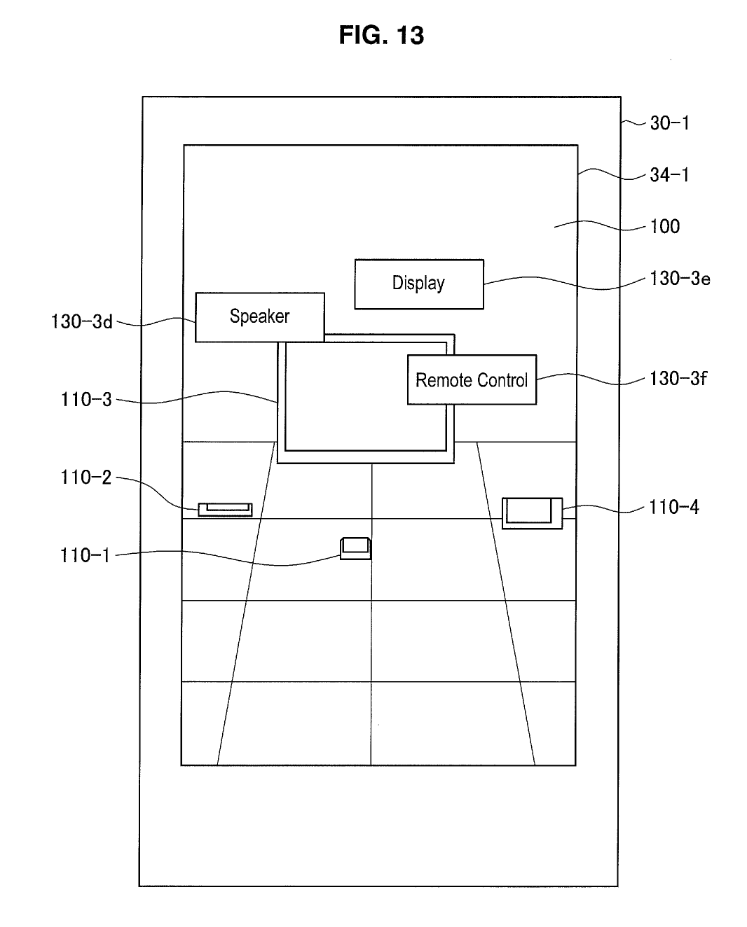

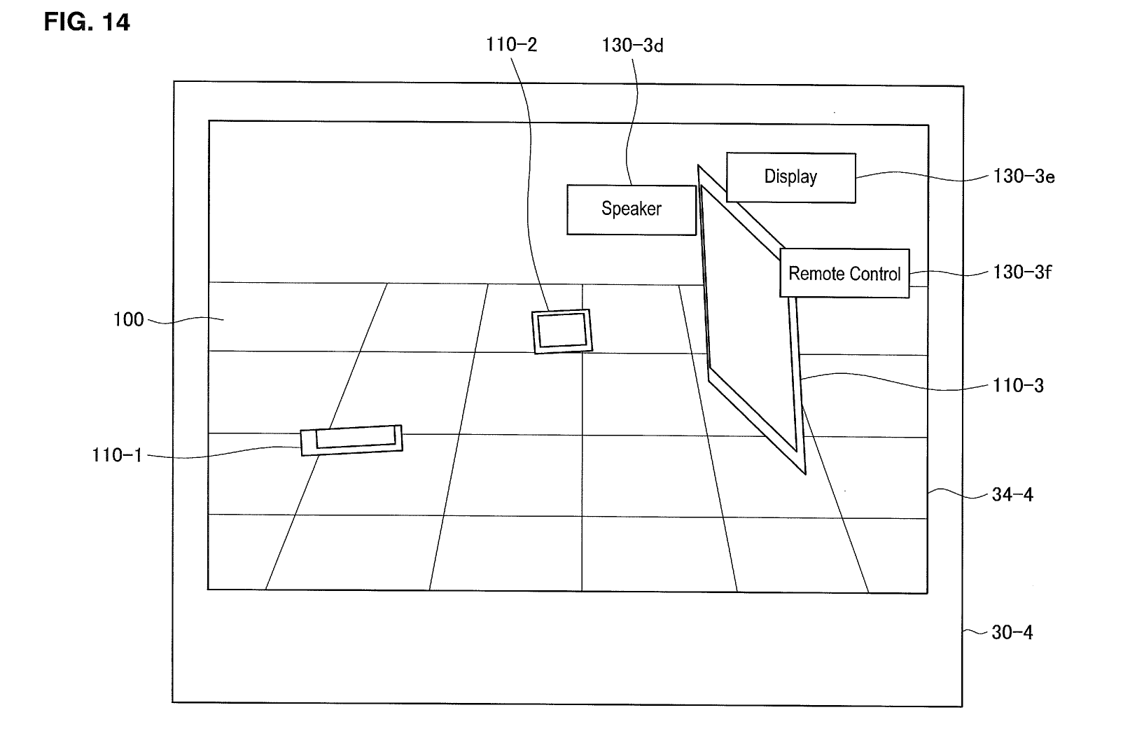

With reference to FIGS. 12 to 14, display examples are explained. As shown in FIG. 12, the communication apparatuses 30-1 to 30-4 are placed in a real space 200 in this example. In the case of this example, the display unit 34-1 of the communication apparatus 30-1 (smartphone) displays the virtual space 100 shown in FIG. 13. In this example, a viewpoint is set to a position behind the communication apparatus 30-1. On the other hand, a display unit 34-4 of the communication apparatus 30-4 (smart tablet) displays the virtual space 100 shown in FIG. 14. Accordingly, since a user of the communication apparatus 30-1 and a user of communication apparatus 30-4 can visually recognize the virtual spaces from viewpoints of their current positions (or positions behind the current positions), the users can easily associate positions of respective communication-apparatus images in the virtual spaces with positions of respective communication apparatuses 30 in the real space.

<4. Operation Using Virtual Space>

In this embodiment, for example, the user can zoom the virtual space in and out, switches display and non-display of the virtual space, shares and transfers content and functions, by operating virtual content or a function-display image in the virtual space. Details will be described below.

(4-1. Procedure of Processing Performed by Information Processing System)

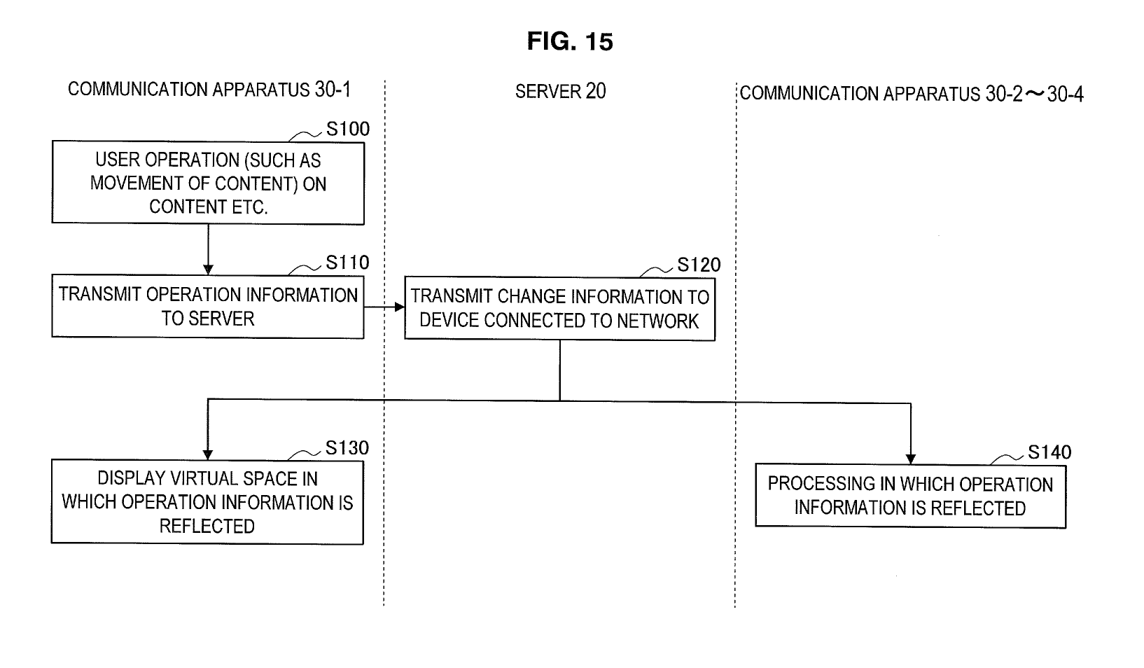

First, with reference to a flowchart shown in FIG. 15, an example of processing performed by the information processing system 10 is explained. In this example, the communication apparatuses 30-1 to 30-4 are connected to a network as a premise. In addition, the communication apparatus 30-1 displays the virtual space. Needless to say, processing to be performed in this embodiment is not limited to this example.

In step S100, the user of the communication apparatus 30-1 performs input operation on virtual content and the like displayed in the virtual space. For example, the user taps desired virtual content and performs a drag-and-drop operation. The input unit 33 outputs operation information to the control unit 36.

In step S110, the control unit 36 outputs the operation information to the communication unit 31. The communication unit 31 transmits the operation information to the server 20.

In step S120, the communication unit 21 of the server 20 receives the operation information and outputs to the control unit 23. On the basis of the operation information, the control unit 23 causes the virtual space to be changed. That is, the control unit 23 generates a virtual space in which the operation information is reflected. Subsequently, the control unit 23 generates virtual-space information about the changed virtual space, and outputs to the communication unit 21. The communication unit 21 transmits the virtual-space information to the communication apparatus 30-1. On the other hand, in the case where it becomes necessary to change processing of any one of communication apparatuses 30 due to the operation information, the control unit 23 generates change information about detailed changes of the processing. Next, the control unit 23 outputs the change information to the communication unit 21, and the communication unit 21 transmits the change information to the any one of the communication apparatuses 30 whose processing has to be changed.

In step S130, the communication unit 31 of the communication apparatus 30-1 receives the virtual-space information and outputs to the control unit 36. The control unit 36 displays the virtual space based on the virtual-space information on the display unit 34. Accordingly, the control unit 36 can display the virtual space in which the operation information is reflected.

In the case of receiving change information, the communication unit 31 of the communication apparatus 30-1 outputs the change information to the control unit 36. The control unit 36 performs processing based on the change information. For example, in the case where the change information indicates non-display of the virtual space, the control unit 36 stops displaying the virtual space and returns to jobs in the communication apparatus 30-1. Accordingly, the communication apparatus 30-1 can performs processing in which the operation information is reflected.

In step S140, in the case of receiving the change information, communication units 31 of the communication apparatuses 30-2 to 30-4 output the change information to control units 36. The control units 36 perform processing according to the change information. For example, in the case where the change information indicates transferring of content, the control units 36 transfer content being executed to another communication apparatus 30. Accordingly, the communication apparatuses 30-2 to 30-4 can perform processing in which the operation information is reflected.

(4-2. Various Display Examples)

Next, there will be explained various display examples which uses the above-described processing.

(4-2-1. Zoom In and Zoom Out of Virtual Space)

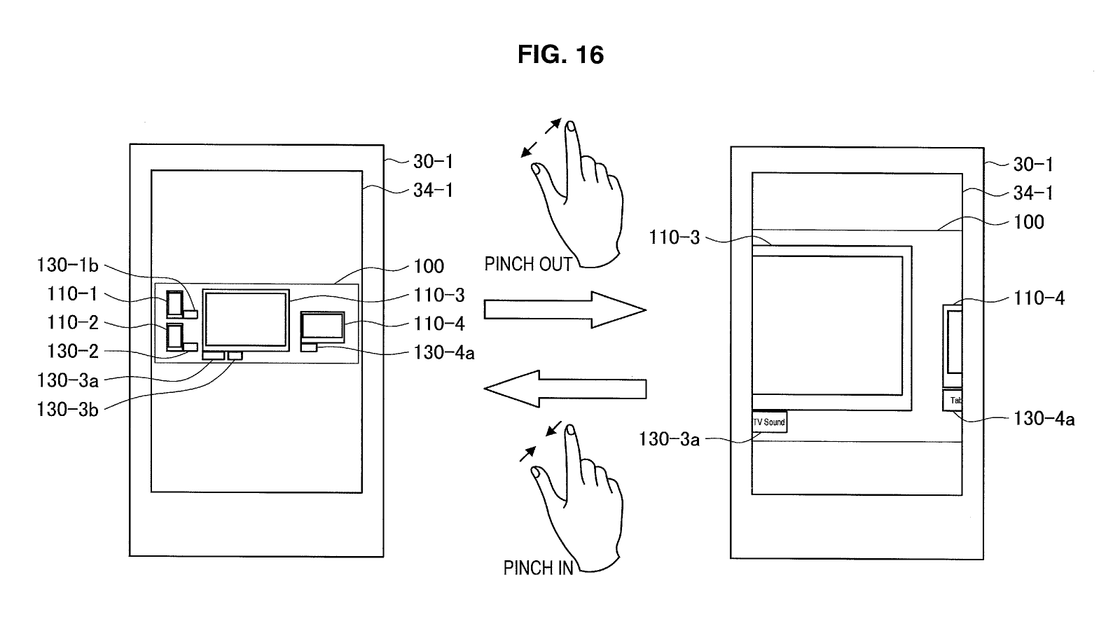

FIG. 16 shows an example of zoom in and zoom out of the virtual space. In this example, as shown in the left-hand side of FIG. 16, the control unit 36 of the communication apparatus 30-1 displays the whole virtual space 100 on the display unit 34-1, for example. The user performs a pinch-out operation on the input unit 33 (that is, touchscreen). In response to this operation, the communication apparatus 30-1 transmits operation information about an operation quantity for pinching out to the server 20. The control unit 23 of the server 20 generates a virtual space having a magnification ratio according to the operation quantity for pinching out, and generates virtual-space information about the virtual space. Subsequently, the communication unit 21 transmits the virtual-space information to the communication apparatus 30-1. Subsequently, as shown in the right-hand side of FIG. 16, the control unit 36 of the communication apparatus 30-1 displays the zoomed-in virtual space 100 based on the virtual-space information.

Next, the user performs a pinch-in operation on the input unit 33. In response to this operation, the communication apparatus 30-1 transmits operation information about an operation quantity for pinching in to the server 20. The control unit 23 of the server 20 generates a virtual space having a reduction ratio according to the operation quantity for pinching in, and generates virtual-space information about the virtual space. Subsequently, the communication unit 21 transmits the virtual-space information to the communication apparatus 30-1. Subsequently, as shown in the left-hand side of FIG. 16, the control unit 36 of the communication apparatus 30-1 displays the zoomed-out virtual space 100 based on the virtual-space information. In this example, the display unit 34-1 displays the whole virtual space 100. Note that, the user can move the zoomed-in virtual space in the display unit 34-1.

(4-2-2. Switching Display/Non-Display of Virtual Space)

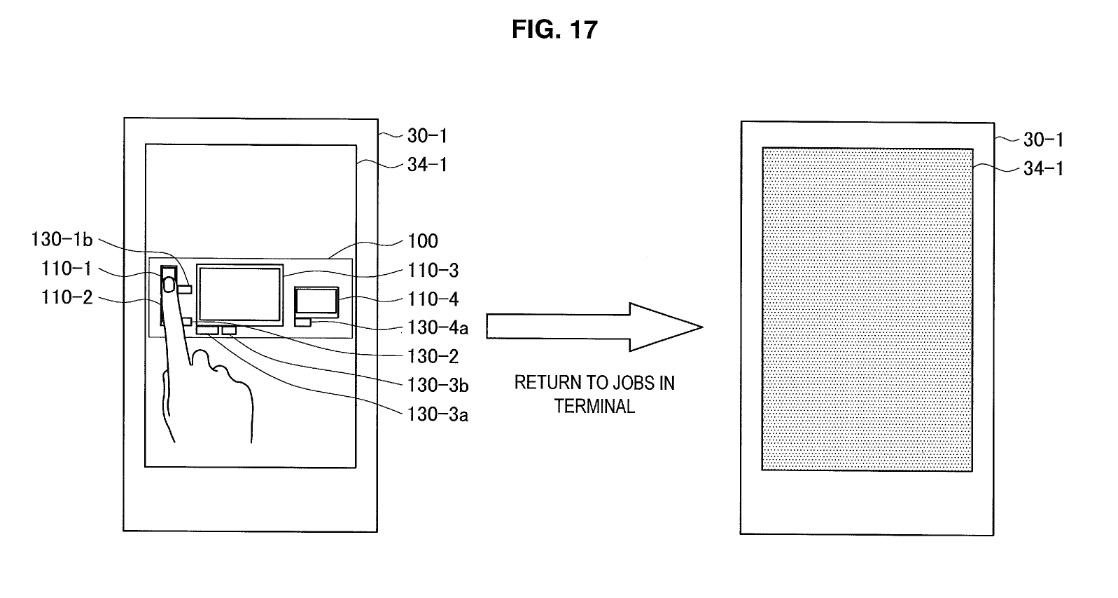

FIG. 17 shows an example of switching display and non-display of the virtual space. In this example, as shown in the left-hand side of FIG. 17, the control unit 36 of the communication apparatus 30-1 first displays the virtual space 100 on the display unit 34-1. The user taps the communication-apparatus image 110-1 indicating the communication apparatus 30-1. In response to this operation, the communication apparatus 30-1 transmits operation information about the detailed operation to the server 20. On the basis of the operation information, the control unit 23 of the server 20 generates change information indicating to stop displaying the virtual space. Subsequently, the control unit 21 transmits the change information to the communication apparatus 30-1. Next, as shown in the right-hand side of FIG. 17, the control unit 36 of the communication apparatus 30-1 stops displaying the virtual space on the basis of the change information, and returns to jobs in the communication apparatus 30-1 (terminal). For example, the control unit 36 again displays content that was displayed before displaying the virtual space. Note that, in the cause where the user taps one of the other communication-apparatus images 110-2 to 110-4, the control unit 23 may display virtual content displayed on the one of the other communication-apparatus images on the display unit 34-1.

(4-2-3. Transfer of Content)

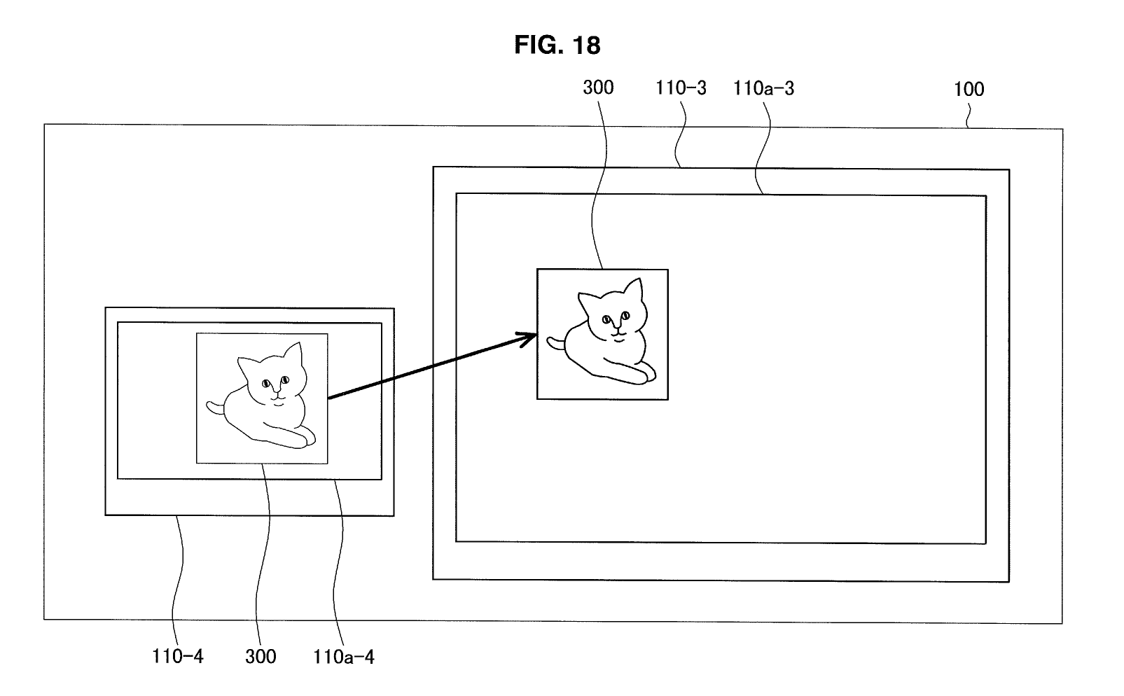

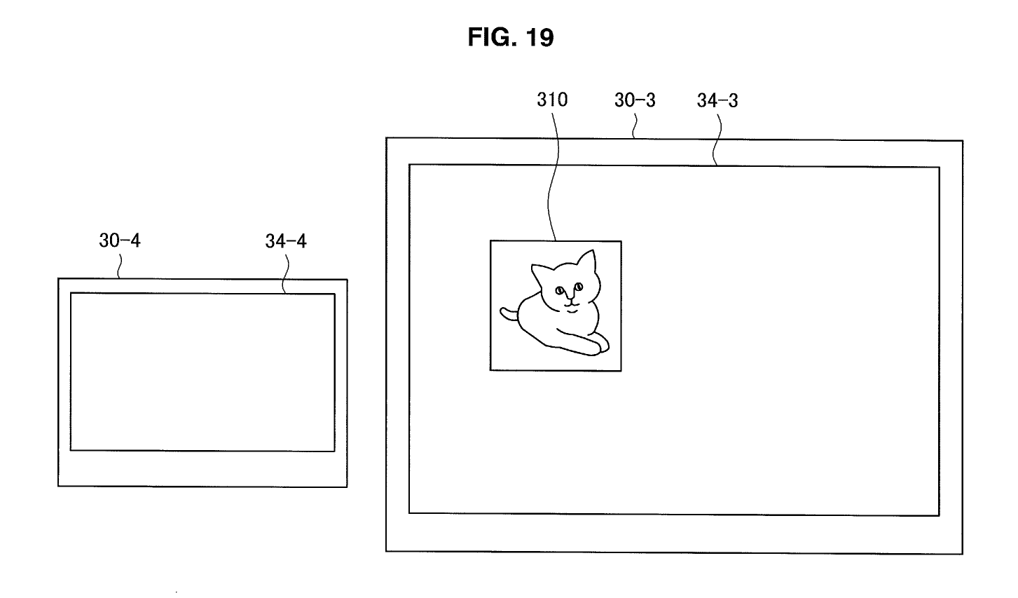

FIGS. 18 and 19 show an example of transfer of content. In this example, content 310 is displayed on the communication apparatus 30-4 as a premise. In addition, virtual content 300 (for example, zoomed-out content 310) representing content 310 is displayed in a display-unit image 110a-4 of the communication-apparatus image 110-4 in the virtual space 100. The virtual space 100 is displayed on the display unit 34-1 of the communication apparatus 30-1.

As shown in FIG. 18, the user taps the virtual content 300 displayed on the display unit 34-1, and moves the virtual content 300 to the display-unit image 110a-3 in the communication-apparatus image 110-3 with keeping a finger on the input unit 33. On the basis of operation information about this operation, the control unit 23 of the server 20 generates a virtual space in which the virtual content 300 in a virtual space moves to the display-unit image 110a-3, and generates virtual-space information about the virtual space. On the basis of the virtual space information, the control unit 36 of the communication apparatus 30-1 displays the virtual space 100 in which the virtual content 300 moves from the display-unit image 110a-4 to the display-unit image 110a-3. That is, the user drags and drops the virtual content 300 to the display-unit image 110a-3 in the communication-apparatus image 110-3.

On the other hand, the control unit 23 generates change information indicating to stop executing the content 310. The communication unit 21 transmits the change information to the communication apparatus 30-4. As shown in FIG. 19, in response to this operation, the control unit 36 of the communication apparatus 30-4 stops executing the content 310.

Furthermore, the control unit 23 generates change information indicating to start executing the content 310. The communication unit 21 transmits this change information to the communication apparatus 30-3. As shown in FIG. 19, in response to this operation, the control unit 36 of the communication apparatus 30-3 starts executing the content 310. That is, the communication unit 30-3 displays the content 310. Accordingly, the content 310 is transferred (relocated) from the communication apparatus 30-3 to the communication apparatus 30-4. Note that, in this example, the whole content 310 is transferred from the communication apparatus 30-3 to the communication apparatus 30-4. However, it is possible that only a part of content is transferred.

(4-2-4. Sharing of Content)

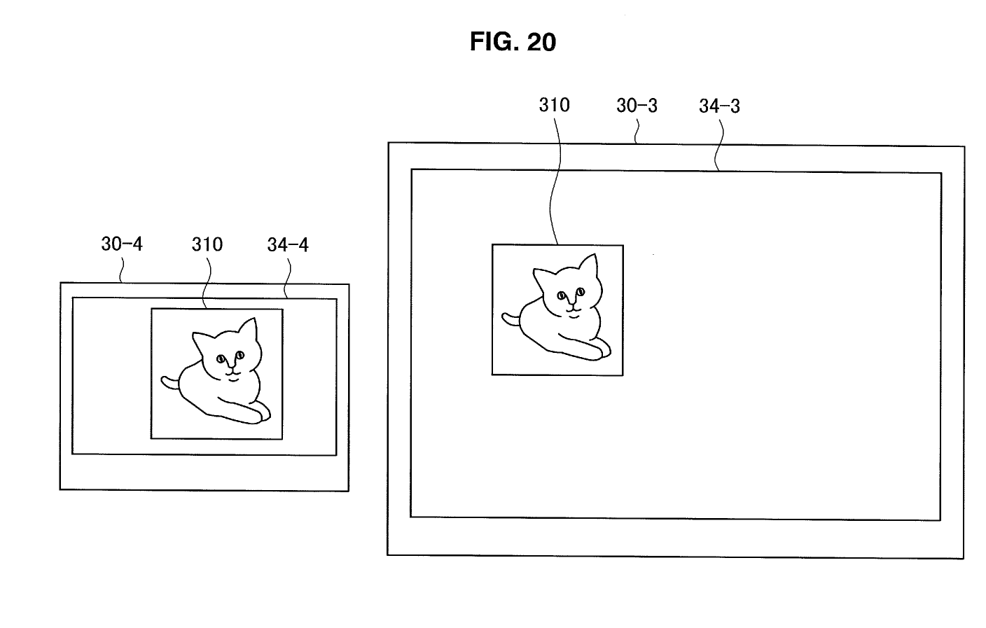

Next, with reference to FIGS. 18 and 20, an example of sharing of content is explained. First, the information processing system 10 performs a same processing as the example of transferring processing up to the above-described drag-and-drop operation.

On the other hand, the control unit generates change information indicating to continue executing the content 310. The communication unit 21 transmits this change information to the communication apparatus 30-4. As shown in FIG. 20, in response to this operation, the control unit 36 of the communication apparatus 30-4 continues executing the content 310.

In addition, the control unit 23 generates change information indicating to start executing the content 310. The communication unit 21 transmits this change information to the communication apparatus 30-3. As shown in FIG. 20, in response to this operation, the control unit 36 of the communication apparatus 30-3 starts executing the content 310. That is, the communication apparatus 30-3 displays the content 310. Accordingly, since both the communication apparatuses 30-3 and 30-4 display the content 310, the content is shared among these communication apparatuses. Note that, in this example, the whole content 310 is shared among the communication apparatuses 30-3 and 30-4. However, it is possible that only a part of content 310 is shared.

In accordance with the examples of transferring and sharing, the user can transfer content being executed by respective communication apparatuses 30 to other communication apparatuses, or can share the content with the other communication apparatuses. Accordingly, transferring and the like of content can be performed with continuing working condition of the content. In addition, since the user can actually visually recognize content which the user desires to transfer or share and then can select the content, the user can more certainly select the content to be transferred or shared.

Note that, the content to be transferred is not limited to content being executed by the communication apparatuses 30. However, the content to be transferred may be content embedded in the communication apparatuses 30 (processing performed in this case will be described later). In addition, the control unit 23 may place an image of a list of content included in the communication apparatuses 30 in the virtual space. Subsequently, the control unit 23 may move the image of the list of content in the virtual space in response to a user operation. Moreover, in the case where the image of the list of content is overlaid on any one of the communication-apparatus images, the control unit 23 may transfer all the content recited in the image of the list of the content to a communication apparatus corresponding to the any one of the communication-apparatus images, at once. Needless to say, sharing can also be performed.

(4-2-5. Sharing of Arbitrarily-Acquired Content)

Content to be shared among respective communication apparatuses 30 is not limited to content being executed by respective communication apparatuses 30, and may be any content. For example, the content to be shared among respective communication apparatuses 30 may be acquired through a network, or may be content stored in the respective communication apparatuses 30 or the server 20.

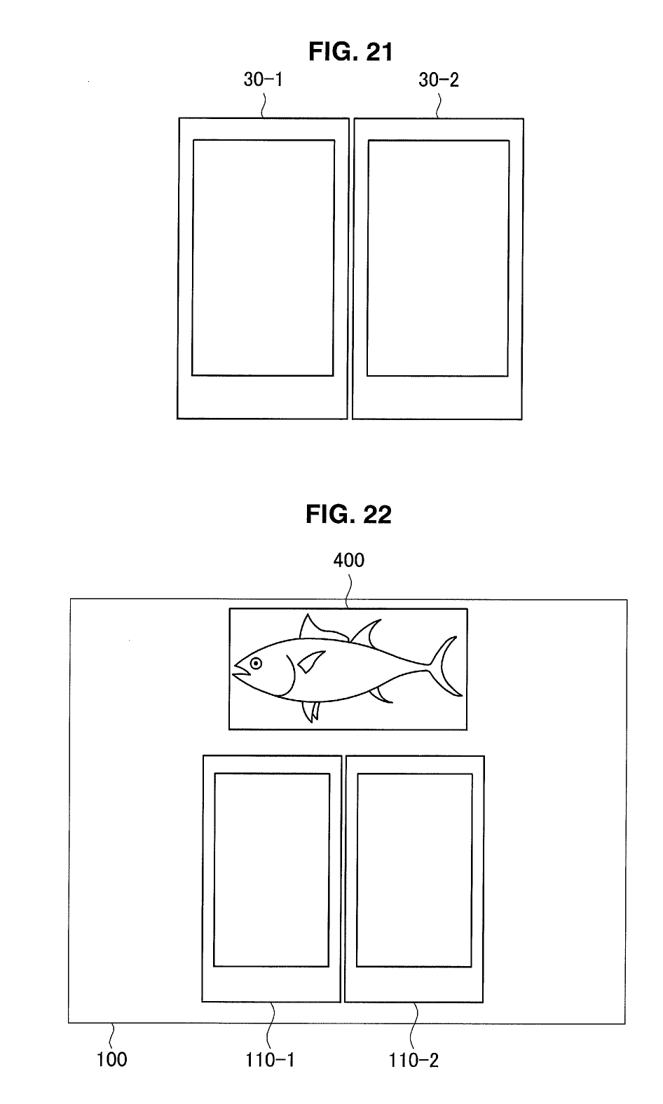

With reference to FIGS. 21 to 24, an example of sharing of arbitrarily-acquired content is explained. Note that, as shown in FIGS. 21 and 22, the communication apparatuses 30-1 and 30-2 are placed next to each other, and this positional relation is reflected in the virtual space 100 in this example. It is also possible that the communication apparatuses 30-1 and 30-2 are away from each other. In addition, the virtual space is displayed on the communication apparatus 30-4 (smart tablet).

The control unit 23 acquires content 410 (image content) from another network through the network 40. Subsequently, as shown in FIG. 22, the control unit 23 places virtual content 400 (for example, zoomed-out content 410) corresponding to the content 410 in the virtual space 100. The control unit 23 generates virtual-space information about the virtual space 100, and the communication unit 21 transmits the virtual-space information to the communication apparatus 30-4. On the basis of the virtual-space information, the control unit 36 of the communication apparatus 30-4 displays the virtual space 100 in which the virtual content 400 is placed.

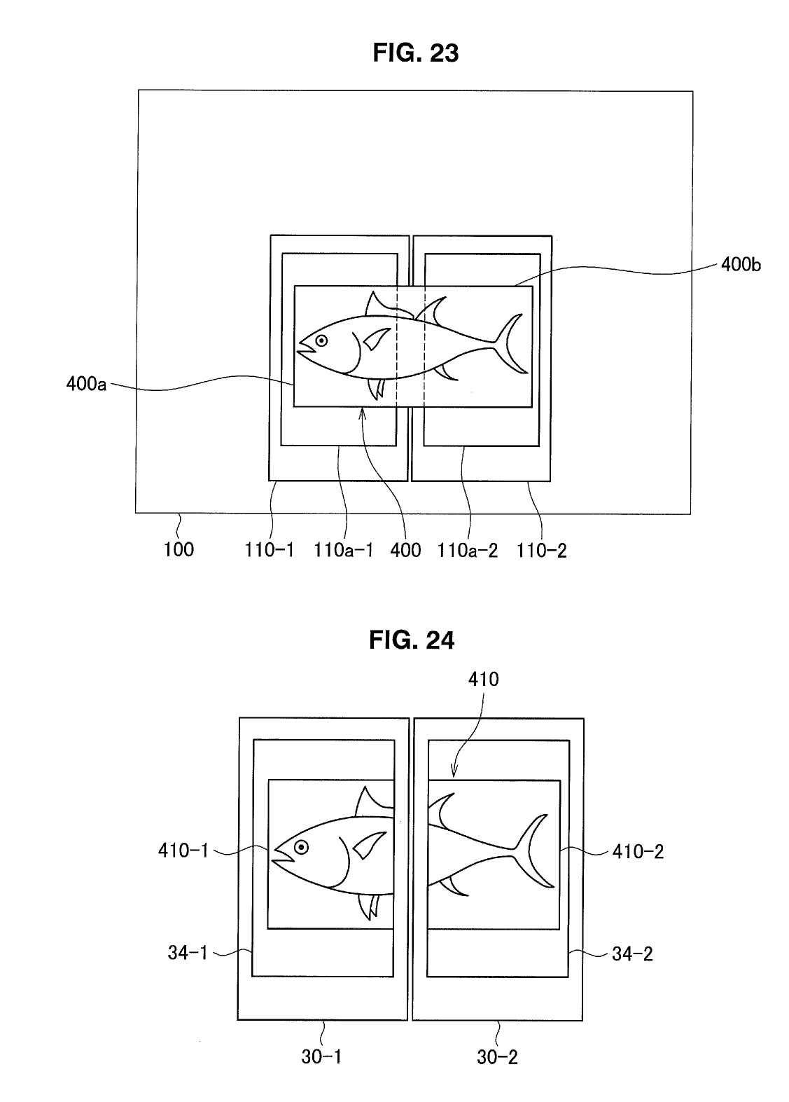

The user taps the virtual content 400 displayed on the display unit 34-4, and moves the virtual content 400 to between the communication-apparatus image 110-1 and the communication-apparatus image 110-2 with keeping a finger on the input unit 33. As shown in FIG. 23, on the basis of operation information about this operation, the control unit 23 of the server 20 generates a virtual space in which the virtual content 400 in a virtual space moves to display-unit images 110a-1 and 110a-2, and generates virtual-space information about the virtual space. On the basis of the virtual space information, the control unit 36 of the communication apparatus 30-4 displays the virtual space 100 in which the virtual content 400 moves to the display-unit images 110a-1 and 110a-2. That is, the user drags and drops the virtual content 400 to the display-unit images 110a-1 and 110a-2. As a result, a part 400a of the virtual content 400 is overlaid on the display-unit image 110a-1, and another part 400b is overlaid on the display-unit image 110a-2.

On the other hand, the control unit 23 generates change information indicating to display content 410-1 corresponding to the virtual content 400a. The communication unit 21 transmits the change information to the communication apparatus 30-1. As shown in FIG. 24, in response to this operation, the control unit 36 of the communication apparatus 30-1 starts executing (displaying) the content 410-1.

In addition, the control unit 23 generates change information indicating to display content 410-2 corresponding to the virtual content 400b. The communication unit 21 transmits the change information to the communication apparatus 30-2. As shown in FIG. 24, in response to this operation, the control unit 36 of the communication apparatus 30-2 starts executing (displaying) the content 410-2. Accordingly, the content 410 is displayed across (shared among) the communication apparatuses 30-1 and 30-2.

In the case where the communication apparatuses 30-1 and 30-2 are away from each other, the following processing is performed, for example. That is, the user drags and drops the virtual content 400a that is the part of the virtual content 400 to the display-unit image 110a-1. Next, the user drags and drops the virtual content 400b that is the another part of the virtual content 400 to the display-unit image 110a-2. In response to this operation, the control unit 23 generates change information that is similar to the above-described change information, and transmits to the communication apparatuses 30-1 and 30-2. Accordingly, the virtual content 410-1 and 410-2 similar to FIG. 24 are displayed on the communication apparatuses 30-1 and 30-2, respectively. Accordingly, the user can cause the communication apparatuses 30 to be cooperated with each other more flexibly.

(4-2-6. Function Transfer Example 1)

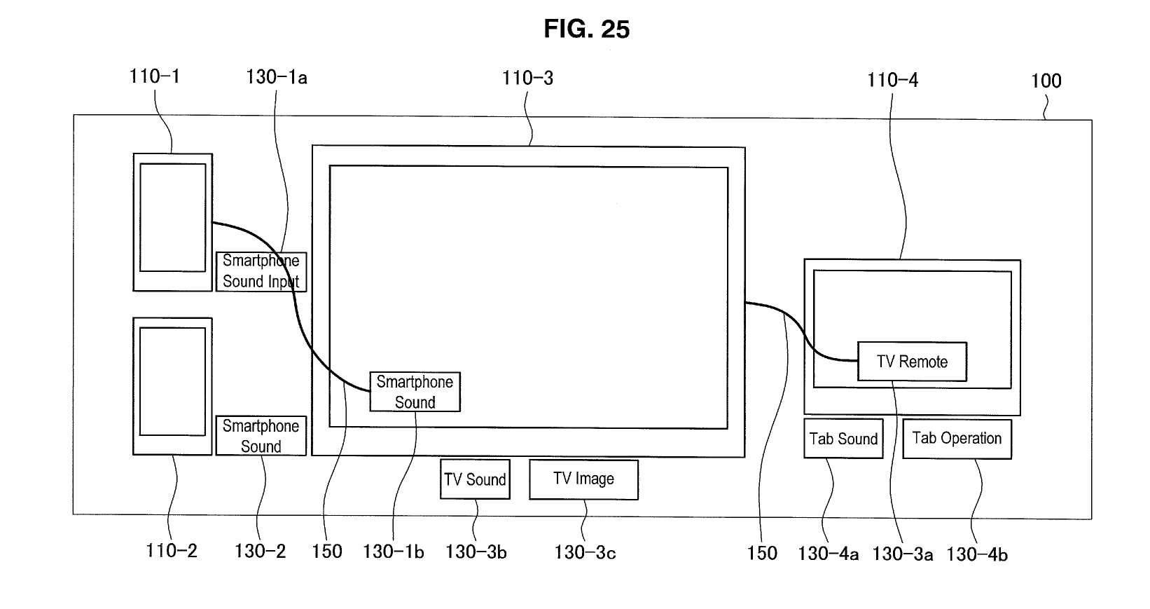

With reference to FIG. 25, there is explained a first example of transferring functions held by the communication apparatuses 30. In a premise, the communication apparatus 30-1 displays the virtual space 100 shown in FIG. 8.

The user taps the function-display image 130-1b on which “Smartphone Sound” is written, and moves the function-display image 130-1b to the communication-apparatus image 110-3 with keeping a finger on the input unit 33. On the basis of operation information about this operation, the control unit 23 of the server 20 generates a virtual space in which the function-display image 130-1b in a virtual space moves to the communication-apparatus image 110-3. In addition, the function-display image 130-1b and the communication-apparatus image 110-1 are tied with a curve image 150. Subsequently, the control unit 23 generates virtual-space information about the virtual space. On the basis of the virtual space information, the control unit 36 of the communication apparatus 30-1 displays the virtual space 100 in which the function-display image 130-1b moves from near the communication-apparatus image 110-1 to the communication-apparatus image 110-3. That is, the user drags and drops the function-display image 130-1b from near the communication-apparatus image 110-1 to the communication-apparatus image 110-3. Accordingly, the function-display image 130-1b positioned near the communication-apparatus image 110-1 is associated with the communication-apparatus image 110-3.

Subsequently, the control unit 23 generates change information indicating to transmit audio content to the communication apparatus 30-3. The communication unit 21 transmits the change information to the communication apparatus 30-1. In response to this operation, the control unit 36 of the communication apparatus 30-1 switches an output destination (transmission destination) of the audio content from the audio output unit 35 of the communication apparatus 30-1 to the communication apparatus 30-3.

In addition, the control unit 23 generates change information indicating to receive the audio content transmitted from the communication apparatus 30-1. The communication unit 21 transmits the change information to the communication apparatus 30-3. In response to this operation, the control unit 36 of the communication apparatus 30-3 receives the audio content transmitted from the communication apparatus 30-1.

That is, in the case where the user requests output of audio content, the control unit 36 of the communication apparatus 30-1 transmits the audio content to the communication apparatus 30-3. Next, the communication unit 31 of the communication apparatus 30-3 receives the audio content, and outputs to the control unit 36 of the communication apparatus 30-3. The control unit 36 of the communication apparatus 30-3 causes the audio output unit 35 of the communication apparatus 30-3 to output the audio content. Accordingly, the user can cause the communication apparatus 30-3 to output the audio content in the communication apparatus 30-1. Note that, the control unit 36 of the communication apparatus 30-1 may cause itself to output the audio content, or may cause itself not to output the audio content. In the former case, an audio output function of the communication apparatus 30-1 is shared among the communication apparatuses 30-1 and 30-3. In the latter case, the audio output function of the communication apparatus 30-1 is transferred to the communication apparatus 30-3. The user may arbitrarily decide which processing the communication apparatus 30-1 performs.

The user further taps the function-display image 130-3a on which “TV Remote” is written, and moves the function-display image 130-3a to the communication-apparatus image 110-4 with keeping the finger on the input unit 33. The control unit 23 of the server 20 and the control unit 36 of the communication apparatus 30-1 perform processing similar to the above. That is, the user drags and drops the function-display image 130-3a from near the communication-apparatus image 110-3 to the communication-apparatus image 110-4. Accordingly, the function-display image 130-3a positioned near the communication-apparatus image 110-3 is associated with the communication-apparatus image 110-4.

In addition, the control unit 23 generates change information indicating to transfer a remote-control function. The communication unit 21 transmits the change information to the communication apparatus 30-4. In response to this operation, the control unit 36 of the communication apparatus 30-4 displays a TV remote-control image on the display unit 34, and receives an input operation from the user.

Furthermore, the control unit 23 generates change information indicating to receive remote-control operation information transmitted from the communication apparatus 30-4. The communication unit 21 transmits the change information to the communication apparatus 30-3. In response to this operation, the control unit 36 of the communication apparatus 30-3 receives the remote-control operation information transmitted from the communication apparatus 30-4.

That is, in the case where the user performs input operation (for example, tapping any one of buttons in the TV remote-control image), the control unit 36 of the communication apparatus 30-4 outputs remote-control operation information about the input operation to the communication unit 31. The communication unit 31 transmits the remote-control operation information to the communication apparatus 30-3. Next, the communication unit 31 of the communication apparatus 30-3 receives the remote-control operation information and transmits to the control unit 36 of the communication apparatus 30-3. The control unit 36 of the communication apparatus 30-3 performs processing according to the remote-control operation information. Accordingly, the user can perform a remote-control operation on the communication apparatus 30-3 by using the communication apparatus 30-4. Note that, the control unit 36 of the communication apparatus 30-3 may receive or reject an operation performed by the remote control. In the former case, a remote-control function of the communication apparatus 30-3 is shared among the communication apparatuses 30-3 and 30-4. In the latter case, the remote-control function of the communication apparatus 30-3 is transferred to the communication apparatus 30-4. The user may arbitrarily decide which processing the communication apparatus 30-3 performs.

As described above, in the first example, the control unit 23 associates a function-display image positioned near any one of the communication-apparatus images with another communication-apparatus image, and causes a communication apparatus corresponding to the another communication-apparatus image to execute a function corresponding to the function-display image. That is, in the first example, a communication apparatus to execute a function represented by a function-display image is a communication apparatus associated with the function-display image. Even in the case where respective function-display images represent names of apparatus, the processing of the first example can be performed in a similar way.

(4-2-7. Function Transfer Example 2)

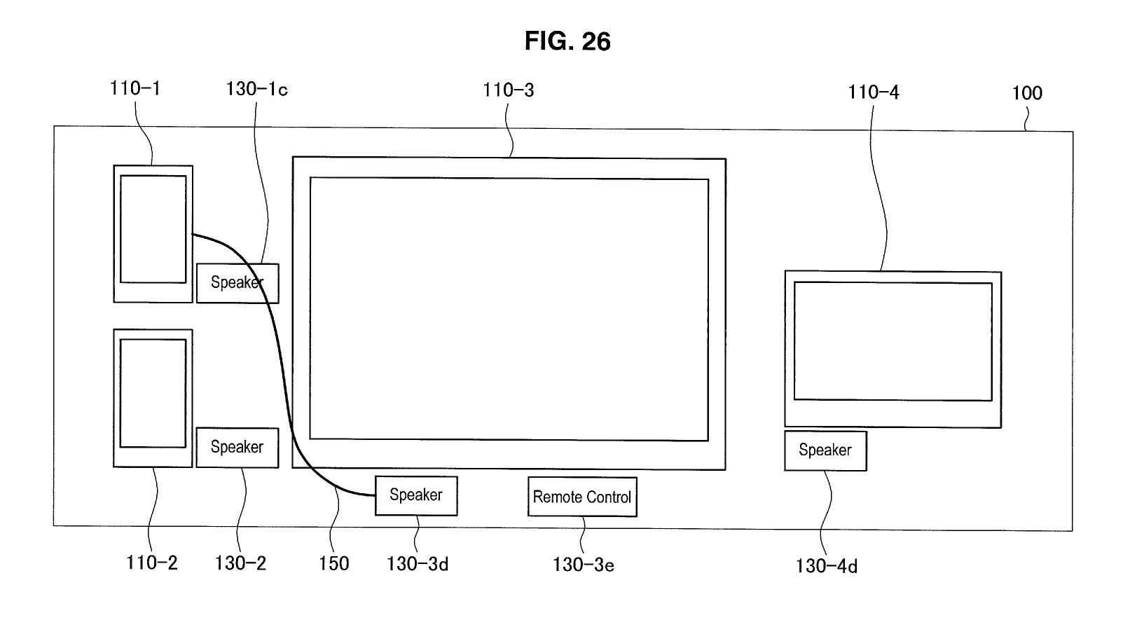

With reference to FIG. 26, there is explained a second example of transferring functions held by the communication apparatus 30. In a premise, the communication apparatus 30-1 displays the virtual space 100 in FIG. 25 in which one of the curve images 150 is omitted.

The user taps the function-display image 130-3d on which “Speaker” is written, and moves the function-display image 130-3d to the communication-apparatus image 110-1 with keeping a finger on the input unit 33. On the basis of operation information about this operation, the control unit 23 of the server 20 ties the function-display image 130-3d and the communication-apparatus image 110-1 with the curve image 150 in the virtual space. Subsequently, the control unit 23 generates virtual-space information about the virtual space. On the basis of the virtual space information, the control unit 36 of the communication apparatus 30-1 displays the virtual space 100 in which the function-display image 130-3d and the communication-apparatus image 110-1 are tied with the curve image 150. Accordingly, the function-display image 130-3d positioned near the communication-apparatus image 110-3 is associated with the communication-apparatus image 110-1.

In addition, the control unit 23 generates change information indicating to transmit the audio content to the communication apparatus 30-3. The communication unit 21 transmits the change information to the communication apparatus 30-1. In response to this operation, the control unit 36 of the communication apparatus 30-1 switches the output destination (transmission destination) of the audio content from the audio output unit 35 of the communication apparatus 30-1 to the communication apparatus 30-3.

In addition, the control unit 23 generates change information indicating to receive the audio content transmitted from the communication apparatus 30-1. The communication unit 21 transmits the change information to the communication apparatus 30-3. In response to this operation, the control unit 36 of the communication apparatus 30-3 receives the audio content transmitted from the communication apparatus 30-1.

That is, in the case where the user requests output of audio content, the control unit 36 of the communication apparatus 30-1 transmits the audio content to the communication apparatus 30-3. Next, the communication unit 31 of the communication apparatus 30-3 receives the audio content, and outputs to the control unit 36 of the communication apparatus 30-3. The control unit 36 of the communication apparatus 30-3 causes the audio output unit 35 of the communication apparatus 30-3 to output the audio content. Accordingly, the user can cause the communication apparatus 30-3 to output the audio content in the communication apparatus 30-1. Note that, the control unit 36 of the communication apparatus 30-1 may cause itself to output the audio content, or may cause itself not to output the audio content. In the former case, an audio output function of the communication apparatus 30-1 is shared among the communication apparatuses 30-1 and 30-3. In the latter case, the audio output function of the communication apparatus 30-1 is transferred to the communication apparatus 30-3. The user may arbitrarily decide which processing the communication apparatus 30-1 performs.

As described above, in the second example, the control unit 23 associates a function-display image positioned near any one of the communication-apparatus images with another communication-apparatus image, and causes a communication apparatus corresponding to the another communication-apparatus image to use a function corresponding to the function-display image. That is, in the second example, the control unit 23 causes a communication apparatus associated with a function-display image to use a function indicated by the function-display image. Even in the case where respective function-display images represent names of functions, the processing of the second example can be performed in a similar way.

In the second example, the way to associate a function-display image with a communication-apparatus image is not limited to the above. For example, the control unit 23 may migrate to a mode to select a name of an apparatus to be used by the communication apparatus 30-1. In the case where the user taps any function-display image during this mode, the function-display image may be associated with the communication-apparatus image 110-1.

(4-2-8. Function Transfer Example 3)

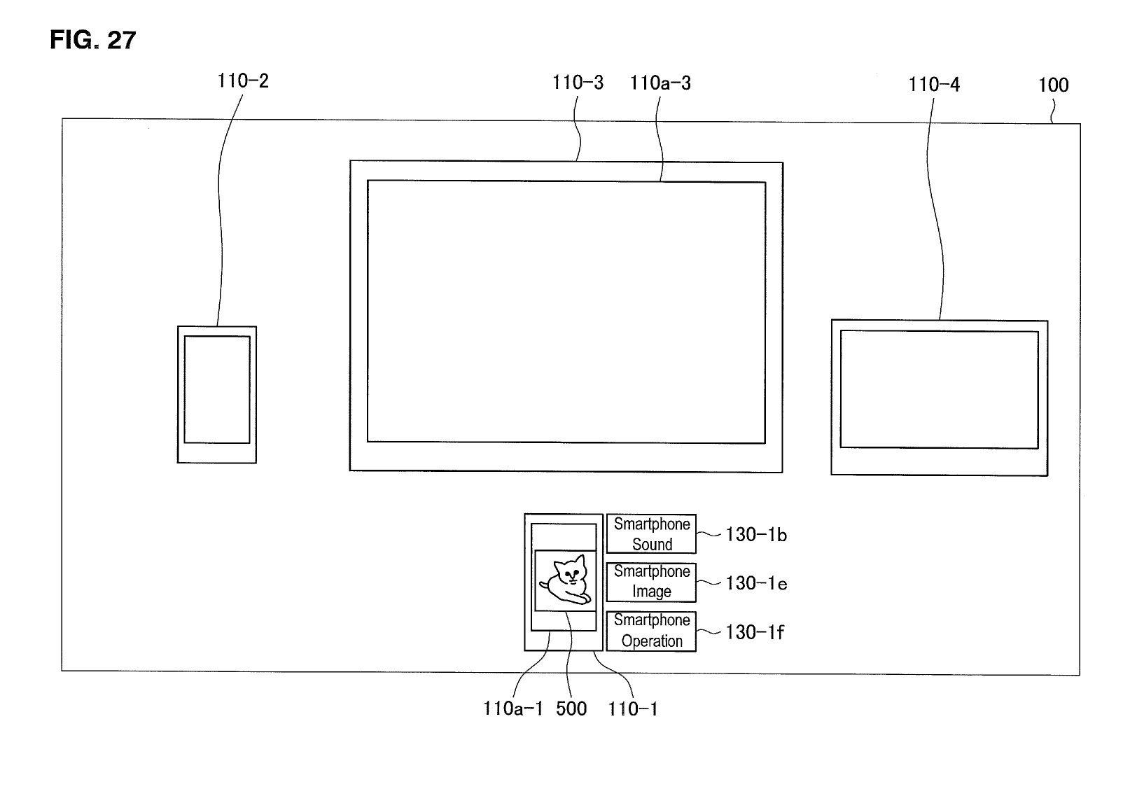

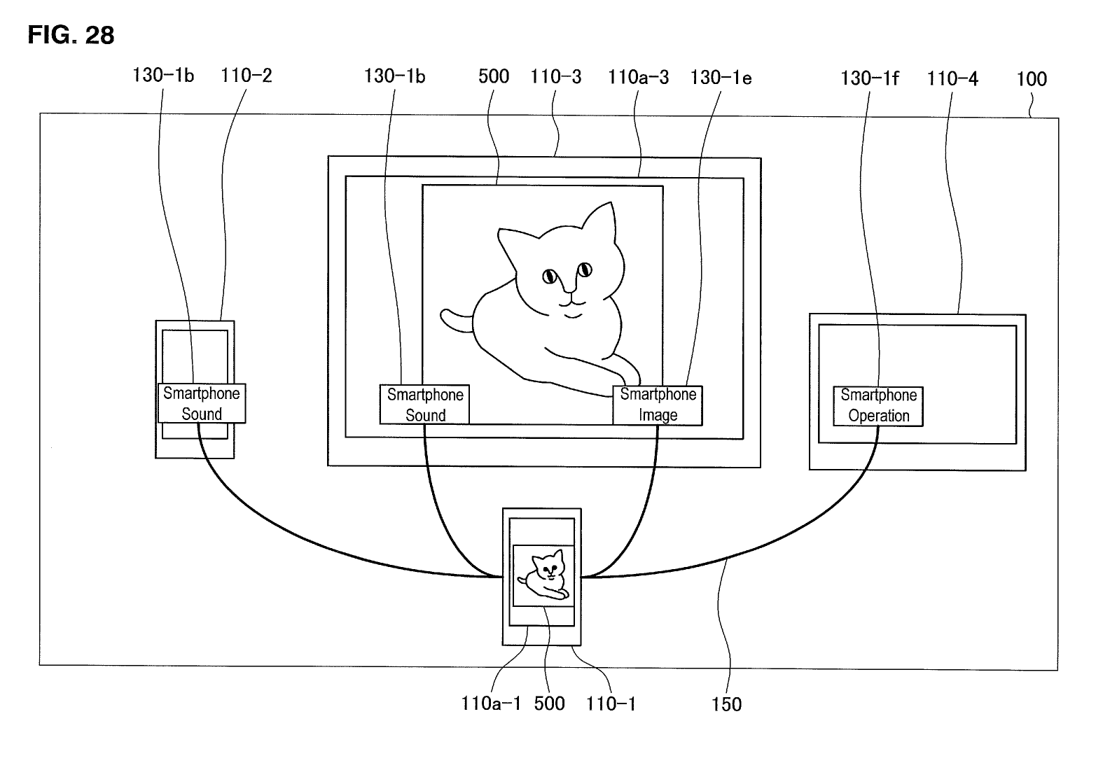

With reference to FIGS. 27 and 28, there is explained a third example of transferring functions held by the communication apparatus 30. The third example is a modification example of the first example. In a premise, the communication apparatus 30-4 displays the virtual space 100 shown in FIG. 27. In the virtual space 100, function-display images 130-1b, 130-1e, and 130-1f are displayed near the communication-apparatus image 110-1. In addition, a virtual content 500 is displayed on the display-unit image 110a-1 of the communication-apparatus image 110-1.

The user taps the function-display image 130-1b on which “Smartphone Sound” is written, and moves the function-display image 130-1b to the communication-apparatus images 110-2 and 110-3 with keeping the finger on the input unit 33. The user further taps the function-display image 130-1e on which “Smartphone Image” is written, and moves the function-display image 130-1e to the communication-apparatus image 110-3 with keeping the finger on the input unit 33. The user further taps the function-display image 130-1f on which “Smartphone Operation” is written, and moves the function-display image 130-1f to the communication-apparatus image 110-4 with keeping the finger on the input unit 33.

In response to the operations, the control unit 23 of the server 20 performs processing similar to the first example on the basis of operation information about details of the respective operations. Accordingly, the control unit 23 generates the virtual space 100 shown in FIG. 28. In the virtual space 100, the function-display image 130-1b is associated with the communication-apparatus image 110-2. Furthermore, the function-display images 130-1b and 130-1e are associated with the communication-apparatus image 110-3. Furthermore, the function-display image 130-1f is associated with the communication-apparatus image 110-4. In addition, the control unit 36 of the communication apparatus 30-4 displays the virtual space 100 on the display unit 34.

The control unit 23 generates change information indicating to transmit the audio content to the communication apparatuses 30-2 and 30-3. The communication unit 21 transmits the change information to the communication apparatus 30-1. In response to this operation, the control unit 36 of the communication apparatus 30-1 switches the output destination (transmission destination) of the audio content from the audio output unit 35 of the communication apparatus 30-1 to the communication apparatuses 30-2 and 30-3.

In addition, the control unit 23 generates change information indicating to receive the audio content transmitted from the communication apparatus 30-1. The communication unit 21 transmits the change information to the communication apparatuses 30-2 and 30-3. In response to this operation, the control units 36 of the communication apparatuses 30-2 and 30-3 receive the audio content transmitted from the communication apparatus 30-1.

That is, in the case where the user requests output of audio content, the control unit 36 of the communication apparatus 30-1 transmits the audio content to the communication apparatuses 30-2 and 30-3. Next, the communication units 31 of the communication apparatuses 30-2 and 30-3 receive the audio content, and output to the control units 36. The control units 36 cause the audio output units 35 to output the audio content. Accordingly, the user can cause the communication apparatuses 30-2 and 30-3 to output the audio content in the communication apparatus 30-1. Note that, the control unit 36 of the communication apparatus 30-1 may cause itself to output the audio content, or may cause itself not to output the audio content.

In addition, the control unit 23 generates change information indicating to transmit the image content to the communication apparatus 30-3. The communication unit 21 transmits the change information to the communication apparatus 30-1. In response to this operation, the control unit 36 of the communication apparatus 30-1 switches the output destination (transmission destination) of the image content from the display unit 34 of the communication apparatus 30-1 to the communication apparatus 30-3.

In addition, the control unit 23 generates change information indicating to receive the image content transmitted from the communication apparatus 30-1. The communication unit 21 transmits the change information to the communication apparatus 30-3. In response to this operation, the control unit 36 of the communication apparatus 30-3 receives the image content transmitted from the communication apparatus 30-1.

That is, in the case where the user requests output of image content, the control unit 36 of the communication apparatus 30-1 transmits the image content to the communication apparatus 30-3. Next, the communication unit 31 of the communication apparatus 30-3 receives the image content, and outputs to the control unit 36 of the communication apparatus 30-3. The control unit 36 of the communication apparatus 30-3 causes the display unit 34 of the communication apparatus 30-3 to output the image content. Accordingly, the user can cause the communication apparatus 30-3 to output the image content in the communication apparatus 30-1. That is, as shown in FIG. 28, the communication-apparatus image 110-3 in the virtual space 100 displays the virtual content 500. Note that, the control unit 36 of the communication apparatus 30-1 may cause itself to output the image content, or may cause itself not to output the image content. In the example shown in FIG. 28, the communication apparatus 30-1 outputs the image content too.

In addition, the control unit 23 generates change information indicating to transfer a input-operation function. The communication unit 21 transmits the change information to the communication apparatus 30-4. In response to this operation, the control unit 36 of the communication apparatus 30-4 receives an input operation from the user, and transmits the operation information to the communication apparatus 30-1.

Furthermore, the control unit 23 generates change information indicating to receive operation information transmitted from the communication apparatus 30-4. The communication unit 21 transmits the change information to the communication apparatus 30-1. In response to this operation, the control unit 36 of the communication apparatus 30-1 receives the operation information transmitted from the communication apparatus 30-4.

That is, in the case where the user performs input operation, the control unit 36 of the communication apparatus 30-4 outputs operation information about the input operation to the communication unit 31. The communication unit 31 transmits the operation information to the communication apparatus 30-1. Next, the communication unit 31 of the communication apparatus 30-1 receives the operation information and transmits to the control unit 36 of the communication apparatus 30-1. The control unit 36 of the communication apparatus 30-1 performs processing according to the operation information. Accordingly, the user can perform a operation on the communication apparatus 30-1 by using the communication apparatus 30-4. Note that, the control unit 36 of the communication apparatus 30-1 may receive or reject an input operation performed by the input unit 33 of the communication apparatus 30-1. In the former case, an input-operation function of the communication apparatus 30-1 is shared among the communication apparatuses 30-1 and 30-4. In the latter case, the input-operation function of the communication apparatus 30-1 is transferred to the communication apparatus 30-4. The user may arbitrarily decide which processing the communication apparatus 30-1 performs.

According to the third example, transferring or sharing of functions can be performed among a communication apparatus and a plurality of communication apparatuses, by using the control unit 23. That is, the control unit 23 can cause the communication apparatus and the plurality of communication apparatuses to be cooperated with each other and to execute content. In addition, the user can cause the communication apparatuses 30 to be cooperated with each other by performing an easy operation such as drag and drop of a function-display image. Since a name of a function or apparatus is written on the function-display image (that is, functions of the communication apparatuses 30 are visualized), the user can intuitively cause the communication apparatuses 30 to be cooperated with each other.

(4-2-9. Example of Operation of Virtual Content in Virtual Space)

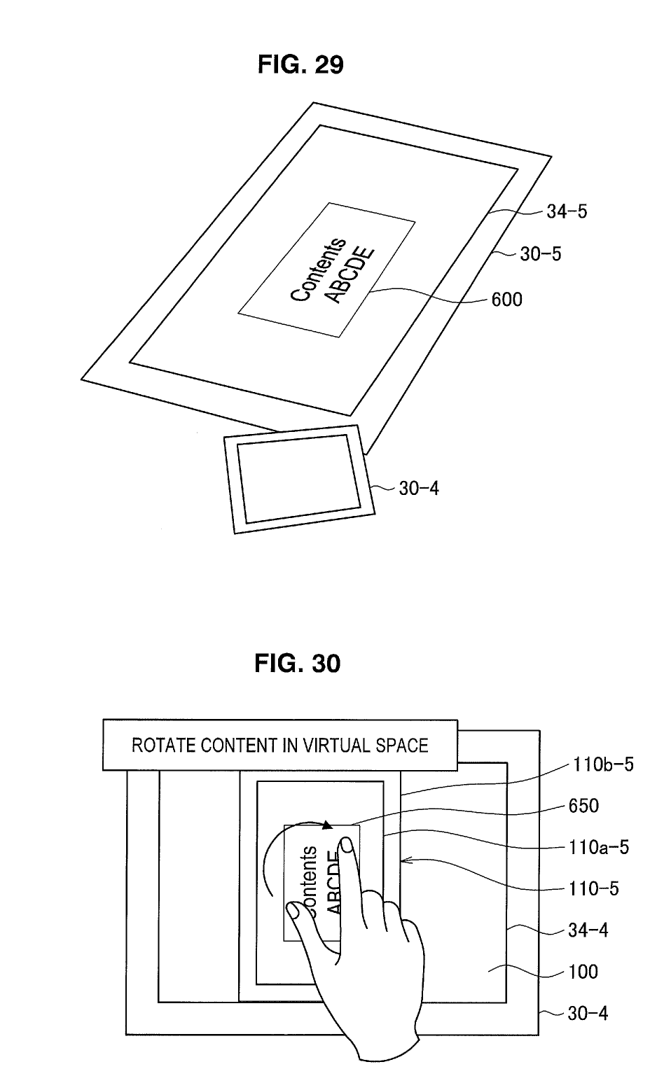

Next, with reference to FIGS. 29 to 32, there is explained an example of an operation of virtual content in a virtual space. In addition to the communication apparatuses 30-1 to 30-4, a communication apparatus 30-5 shown in FIG. 29 is connected to the network 40 in a premise. The communication apparatus 30-5 has an enormous display unit 34-5. For example, the communication apparatus 30-5 is a table-type display whose whole table top is the display unit 34-5.

The display unit 34-5 of the communication apparatus 30-5 displays the content 600 (image content). The display unit 34-4 of the communication apparatus 30-4 displays the virtual space 100 shown in FIG. 30. In the virtual space 100, the communication-apparatus image 110-5 is displayed, the communication-apparatus image 110-5 representing the communication apparatus 30-5 and the content 600 being executed by the communication apparatus 30-5. Note that, it is also possible that the communication-apparatus images 110-1 to 110-4 are displayed in the virtual space 100 as with the above examples. However, they are omitted in this example.

The communication-apparatus image 110-5 includes a main-body image 110b-5 representing the communication apparatus 30-5, and virtual content 650 representing the content 600. The virtual content 650 is displayed on a display-unit image 110a-5 of the main-body image 110b-5.

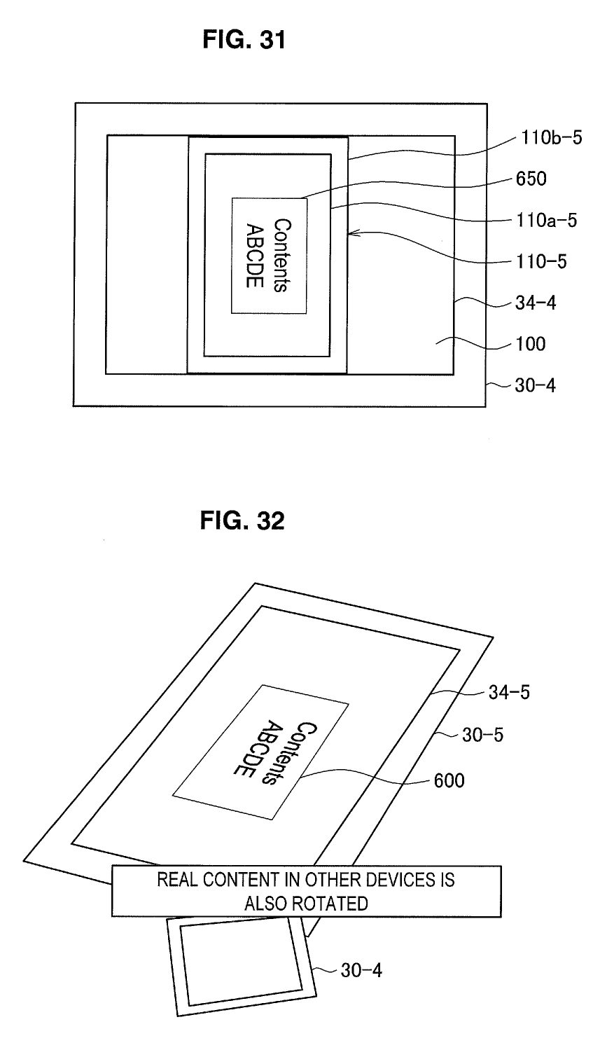

For example, the user taps and rotates the virtual content 650 towards the right with keeping the finger on the display unit 34-4. The control unit 23 of the server 20 rotates the virtual content 650 in the virtual space on the basis of operation information about details of the operation, and generates a new virtual space. Subsequently, the control unit 23 generates virtual-space information about the new virtual space. On the basis of the virtual-space information, the control unit 36 of the communication apparatus 30-4 displays the virtual space in which the virtual content 650 is rotated. A display example is shown in FIG. 31.

In addition, the control unit 23 generates change information indicating to rotate the content 600. The communication unit 21 transmits the change information to the communication apparatus 30-5. In response to this operation, the control unit 36 of the communication apparatus 30-5 rotates the content 600. A display example is shown in FIG. 32.

As described above, the control unit 23 changes the virtual content 650 on the communication-apparatus image 110-5 on the basis of a user operation. Subsequently, the control unit 23 displays the content 600 (rotated content 600 in the above example) corresponding to changed virtual content 650 on the communication apparatus 30-5 corresponding to the communication-apparatus image 110-5. Accordingly, the user can operate real content by operating the virtual content in the virtual space. Needless to say, operations performed by a user are not limited to the above. For example, user can also move the virtual content in parallel. Accordingly, the user can move the content 600 to near another user around the communication apparatus 30-5, for example.

As described above, according to this embodiment, the server 30 places, in the virtual space, the communication apparatuses 30 and communication-apparatus images representing content being executed by the communication apparatuses 30, and performs control to display the virtual space. Accordingly, by visually recognizing the virtual space, the user can intuitively recognize the communication apparatuses 30 connected to the network 40 and the content being executed by the respective communication apparatus 30, in overhead view.

In addition, since the server 20 generates communication-apparatus images corresponding to the respective communication apparatuses 30 connected to the network 40, the user can intuitively recognize the content being executed by the respective communication apparatus 30, in overhead view. That is, the user can intuitively recognize the network in perspective, in overhead view.

In addition, the server 20 places virtual content in the virtual space, and displays at least one of pieces of the virtual content out of the pieces of the virtual content on any one of the communication-apparatus images on the basis of a user operation. The server 20 further causes one of the communication apparatuses 30 corresponding to the any one of the communication-apparatus images to execute content corresponding to the one of the pieces of virtual content. Accordingly, since the user can perform transferring or sharing of content in the virtual space, the user can intuitively performs such operations.

In addition, on the basis of the user operation, the server 20 displays, on another communication-apparatus image, at least one of pieces of virtual content out of the pieces of the virtual content on one of the communication-apparatus images. The server 20 further causes another communication apparatus 30 corresponding to the another communication-apparatus image to execute content corresponding to the one of the pieces of virtual content. Accordingly, since the user can perform transferring or sharing of content among the communication apparatuses 30 in the virtual space, the user can intuitively performs such operations.

In addition, the server 20 causes the another communication apparatus 30 to execute content corresponding to the one of the pieces of virtual content. On the other hand, the server 20 causes the one of the communication apparatuses 30 corresponding to the one of the communication-apparatus images to stop executing the content corresponding to the one of the pieces of virtual content. That is, the server 20 can transfer the content from the one of the communication apparatuses 30 to the another communication apparatus 30 on the basis of a user operation. Accordingly, the user can intuitively transfer the content.

In addition, the server 20 causes the another communication apparatus 30 to execute the content corresponding to the one of the pieces of virtual content, and causes the one of the communication apparatuses 30 corresponding to the one of the communication-apparatus images to continue executing the content corresponding to the one of the pieces of virtual content. That is, the server 20 can cause the content to be shared among the one of the communication apparatuses 30 and the another communication apparatus 30 on the basis of a user operation. Accordingly, the user can intuitively share the content.

In addition, in the case where one of the communication apparatuses 30 does not have the display unit 34, the server 20 places an operation image 140 used for operating the one of the communication apparatuses 30 near a communication-apparatus image. Accordingly, even if the one of the communication apparatuses 30 does not have the display unit 34, the user can intuitively operate the one of the communication apparatuses 30 in the virtual space.

In addition, the server 20 changes virtual content on a communication-apparatus image on the basis of a user operation, and causes one of the communication apparatuses 30 corresponding to the communication-apparatuses image to execute content corresponding to the changed virtual content. Accordingly, the user can operate real content by operating the virtual content in the virtual space. Accordingly, the user can intuitively operate the content.

In addition, the server 20 places function-display images near the communication apparatuses 30 in the virtual space, the function-display images indicating functions held by the communication apparatuses 30. Accordingly, since functions held by the communication apparatuses 30 are visualized, the user can intuitively recognize the functions held by the respective communication apparatuses 30 in overhead view.

In addition, the control unit 23 associates a function-display image placed near a communication-apparatus image with another communication-apparatus image on the basis of a user operation, and causes a communication apparatus 30 corresponding to the another communication-apparatus image to execute the function corresponding to the function-display image. That is, on the basis of the user operation, the server 20 can transfer a function of one of the communication apparatuses 30 to another one of the communication apparatuses 30. Accordingly, the user can intuitively transfer functions.

In addition, the control unit 23 associates a function-display image placed near a communication-apparatus image with another communication-apparatus image on the basis of a user operation, and causes a communication apparatus 30 corresponding to the another communication-apparatus image to use the function corresponding to the function-display image. That is, on the basis of the user operation, the server 20 can cause another one of the communication apparatuses 30 to use a function of one of the communication apparatuses 30. Accordingly, the user can intuitively select functions to be used by the another one of the communication apparatuses 30.

It should be understood by those skilled in the art that various modifications, combinations, sub-combinations and alterations may occur depending on design requirements and other factors insofar as they are within the scope of the appended claims or the equivalents thereof.

For example, in the above embodiments, the server 20 generates the virtual space and controls display. However, it is also possible that any one of the communication apparatuses 30 is set as a parent apparatus and this parent apparatus generates the virtual space and controls display.

Additionally, the present technology may also be configured as below.

(1) An information processing apparatus including:

a communication unit that is capable of communicating with a communication apparatus through a communication network; and

a control unit configured to perform control to place, in a virtual space, a communication-apparatus image that represents the communication apparatus and content being executed by the communication apparatus, and to display the virtual space.

(2) The information processing apparatus according to (1),

wherein there are a plurality of communication apparatuses that are connected to the communication network, and

wherein the communication unit generates the communication-apparatus image for each of the communication apparatuses.

(3) The information processing apparatus according to (1) or (2),

wherein, while placing pieces of virtual content in a virtual space and displaying at least one of the pieces of virtual content on any one of communication-apparatus images on the basis of a user operation, the control unit causes a communication apparatus corresponding to the one of communication-apparatus images to execute content corresponding to the one of the pieces of virtual content.

(4) The information processing apparatus according to any one of (1) to (3),

wherein, while displaying at least one of pieces of virtual content out of the pieces of virtual content on a communication-apparatus image on another communication-apparatus image on the basis of a user operation, the control unit causes another communication apparatus corresponding to the another communication-apparatus image to execute content corresponding to the one of the pieces of virtual content.

(5) The information processing apparatus according to (4),

wherein, while causing the another communication apparatus to execute the content corresponding to the one of the pieces of virtual content, the control unit causes a communication apparatus corresponding to the communication-apparatus image to stop executing the content corresponding to the one of the pieces of virtual content.

(6) The information processing apparatus according to (4),

wherein, while causing the another communication apparatus to execute the content corresponding to the one of the pieces of virtual content, the control unit causes a communication apparatus corresponding to the communication-apparatus image to continue executing the content corresponding to the one of the pieces of virtual content.

(7) The information processing apparatus according to any one of (1) to (6),

wherein, in a case where the communication apparatus does not have a display unit, the control unit causes an operation image for operating the communication apparatus to be placed near the communication-apparatus image.

(8) The information processing apparatus according to any one of (1) to (7),

wherein, while causing virtual content on the communication-apparatus image to be changed on the basis of a user operation, the control apparatus causes a communication apparatus corresponding to the communication-apparatus image to execute content corresponding to the changed virtual content.

(9) The information processing apparatus according to any one of (1) to (8),

wherein the control unit causes a function-display image indicating a function of the communication apparatus to be placed near the communication-apparatus image in the virtual space.

(10) The information processing apparatus according to (9),

wherein, while associating a function-display image placed near a communication-apparatus image with another communication-apparatus image on the basis of a user operation, the control unit causes a communication apparatus corresponding to the another communication-apparatus image to execute a function corresponding to the communication-apparatus image.

(11) The information processing apparatus according to (9),

wherein, while associating a function-display image placed near a communication-apparatus image with another communication-apparatus image on the basis of a user operation, the control unit allows a communication apparatus corresponding to the another communication-apparatus image to use a function corresponding to the communication-apparatus image.

(12) An information processing method including:

communicating with a communication apparatus through a communication network; and

performing control to place, in a virtual space, a communication-apparatus image that represents the communication apparatus and content being executed by the communication apparatus, and to display the virtual space.

(13) An program for causing a computer to achieve:

a communication function that is capable of communicating with a communication apparatus through a communication network; and

a control function configured to perform control to place, in a virtual space, a communication-apparatus image that represents the communication apparatus and content being executed by the communication apparatus, and to display the virtual space.

What is claimed is:

1. An information processing apparatus comprising:
a communication unit that is capable of communicating with a communication apparatus through a communication network; and
a control unit configured to perform control to place, in a virtual space, a communication-apparatus image that represents the communication apparatus and content being executed by the communication apparatus, and to display the virtual space.

2. The information processing apparatus according to claim 1,
wherein there are a plurality of communication apparatuses that are connected to the communication network, and
wherein the communication unit generates the communication-apparatus image for each of the communication apparatuses.

3. The information processing apparatus according to claim 1,
wherein, while placing pieces of virtual content in a virtual space and displaying at least one of the pieces of virtual content on any one of communication-apparatus images on the basis of a user operation, the control unit causes a communication apparatus corresponding to the one of communication-apparatus images to execute content corresponding to the one of the pieces of virtual content.

4. The information processing apparatus according to claim 1,
wherein, while displaying at least one of pieces of virtual content out of the pieces of virtual content on a communication-apparatus image on another communication-apparatus image on the basis of a user operation, the control unit causes another communication apparatus corresponding to the another communication-apparatus image to execute content corresponding to the one of the pieces of virtual content.

5. The information processing apparatus according to claim 4,
wherein, while causing the another communication apparatus to execute the content corresponding to the one of the pieces of virtual content, the control unit causes a communication apparatus corresponding to the communication-apparatus image to stop executing the content corresponding to the one of the pieces of virtual content.

6. The information processing apparatus according to claim 4,
wherein, while causing the another communication apparatus to execute the content corresponding to the one of the pieces of virtual content, the control unit causes a communication apparatus corresponding to the communication-apparatus image to continue executing the content corresponding to the one of the pieces of virtual content.

7. The information processing apparatus according to claim 1, wherein, in a case where the communication apparatus does not have a display unit, the control unit causes an operation image for operating the communication apparatus to be placed near the communication-apparatus image.

8. The information processing apparatus according to claim 1,
wherein, while causing virtual content on the communication-apparatus image to be changed on the basis of a user operation, the control apparatus causes a communication apparatus corresponding to the communication-apparatus image to execute content corresponding to the changed virtual content.

9. The information processing apparatus according to claim 1,
wherein the control unit causes a function-display image indicating a function of the communication apparatus to be placed near the communication-apparatus image in the virtual space.

10. The information processing apparatus according to claim 9,
wherein, while associating a function-display image placed near a communication-apparatus image with another communication-apparatus image on the basis of a user operation, the control unit causes a communication apparatus corresponding to the another communication-apparatus image to execute a function corresponding to the communication-apparatus image.

11. The information processing apparatus according to claim 9,
wherein, while associating a function-display image placed near a communication-apparatus image with another communication-apparatus image on the basis of a user operation, the control unit allows a communication apparatus corresponding to the another communication-apparatus image to use a function corresponding to the communication-apparatus image.

12. An information processing method comprising:
communicating with a communication apparatus through a communication network; and
performing control to place, in a virtual space, a communication-apparatus image that represents the communication apparatus and content being executed by the communication apparatus, and to display the virtual space.

13. An program for causing a computer to achieve:
a communication function that is capable of communicating with a communication apparatus through a communication network; and
a control function configured to perform control to place, in a virtual space, a communication-apparatus image that represents the communication apparatus and content being executed by the communication apparatus, and to display the virtual space.
